(19) United States
(12) Patent Application Publication
(10) Pub. No.: US 2018/0079871 A1
(43) Pub. Date: Mar. 22, 2018

(54) Foams and Films Using Specialized Lignin

(71) Applicant: Sweetwater Energy, Inc., Rochester, NY (US)

(72) Inventor: Scott TUDMAN, Honeoye Falls, NY (US)

(21) Appl. No.: 15/709,335

(22) Filed: Sep. 19, 2017

Related U.S. Application Data
(60) Provisional application No. 62/396,740, filed on Sep. 19, 2016.

(51) Int. Cl. C08H 7/00; C08J 5/18; C08J 9/14

(52) U.S. Cl. CPC C08H 6/00; C08J 5/18; C08J 2203/142; C08J 2397/02; C08J 9/146

(57) ABSTRACT

This disclosure provides polymer and film derivatives of specialized clean lignin with improved properties. This disclosure also provides methods of making polymer and film derivatives of specialized clean lignin with improved properties.

### CROSS-REFERENCE

This application claims the benefit of U.S. Provisional Application No. 62/396,740, filed Sep. 19, 2016, which application is incorporated herein by reference in its entirety.

### BACKGROUND OF THE INVENTION

In recent years, there has been great interest in protecting the environment by using products made from natural renewable resources rather than fossil fuel derivatives. Lignin is one substance that has been overlooked as a resource for such products. This may be because lignin is often a byproduct of harsh processes to extract cellulose and other components of biomass, and it can be difficult and expensive to clean after such extractions. For example, lignin substances produced as a byproduct of the cellulose industry, which often uses extreme pretreatments of lignocellulosic materials, can come at high costs of cleaning such materials and often have inferior and inconsistent properties as compared to synthetically-derived products. Most of this lignin is formed into pellets or bricks and burned.

Yet lignin is one of the most common organic substances on earth and has considerably improved material properties compared to other natural polymers. It is characterized by a relatively high strength, rigidity, impact strength, and high resistance with respect to ultraviolet light. It is also flame resistant.

The production of lignin polymers and films has been inhibited by the cost of cleaning and modifying the type of lignin produced in most cellulose extraction processes. A more uniform and low-cost hydrophobic lignin is needed for industrial scale production of usable polymers and films.

The present disclosure provides lignin with improved properties and improved lignin-based polymers, including, but not limited to, foams and films.

### SUMMARY OF THE INVENTION

In one aspect, provided herein is a polyurethane product comprising a polymerization product of an isocyanate and polyols that comprise a lignin product; wherein the polyurethane product has a higher compressive strength than polyurethane made under same conditions except without the lignin product; and wherein the lignin product is a solid residue from a pretreatment and hydrolysis of a biomass, whereby at least 80% of carbohydrates in the biomass are extracted and separated from the solid residue.

In another aspect, provided herein is a polyurethane product comprising a polymerization product of an isocyanate and polyols that comprise a lignin product, the lignin product being made by: (a) pretreating a biomass within a pretreatment unit at an elevated temperature and pressure to produce a pretreated biomass; (b) hydrolyzing the pretreated biomass to produce soluble carbohydrates and lignin residue; and (c) water washing and drying the lignin residue to produce the lignin product.

In another aspect, provided herein is a polyurethane foam comprising a polymerization product of an isocyanate and a lignin-containing solution, the lignin-containing solution formed by dissolving a powdered lignin directly in a solution comprising polyols other than lignin.

In another aspect, provided herein is a method of preparing a polyurethane product comprising: contacting an isocyanate with polyols that comprise a lignin product under conditions sufficient for a polymerization reaction to produce the polyurethane product; wherein the polyurethane product has a higher compressive strength than polyurethane made under same conditions except without the lignin product; and wherein the lignin product is a solid residue from a pretreatment and hydrolysis of a biomass, whereby at least 80% of carbohydrates in the biomass are extracted and separated from the solid residue.

In another aspect, provided herein is a method of preparing a polyurethane product comprising: (a) pretreating a biomass within a pretreatment unit at an elevated temperature and pressure to produce a pretreated biomass; (b) hydrolyzing the pretreated biomass to produce soluble carbohydrates and lignin residue; (c) water washing and drying the lignin residue to produce a lignin product; and (d) contacting an isocyanate with polyols that comprise the lignin product under conditions sufficient for a polymerization reaction to produce the polyurethane product.

In another aspect, provided herein is a method of making a polyurethane foam, comprising: (a) dissolving a powdered lignin directly in a solution comprising polyols other than lignin; and (b) contacting the lignin-containing solution with an isocyanate and submitting the mixture for polymerization to produce the polyurethane foam.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a diagram depicting one embodiment of a pretreatment process, showing the biomass feedstock entering the hydrolysis process system, thereby producing sugar hydrolysate products (sugar stream) and a lignin residue solids product.

FIG. 2 is a graph showing the range of lignin residue particle size distribution following pretreatment through an extruder according to one exemplary embodiment.

FIG. 3A is a photograph comparing polyurethane foams with and without liquefied lignin polyol; FIG. 3B is a photograph of the polyurethane foams of FIG. 3A arranged according to the height of the foams.

### DETAILED DESCRIPTION OF THE INVENTION

The following description and examples illustrate some exemplary embodiments of the disclosure in detail. Those of skill in the art will recognize that there are numerous variations and modifications of this disclosure that are encompassed by its scope. Accordingly, the description of a certain exemplary embodiment should not be deemed to limit the scope of the present disclosure.

Much of the woody feedstock used in cellulose extraction produces pulp and paper industrial by-products through the Kraft process, while other processes that result in a lignin-rich residue can only obtain lignin residue that is highly-sulfonated, thereby the reactive sites on the lignin molecules are blocked.

Further, all of these types of processes, whether the lignin feedstock is the whole or partial plant, or produced by an extraction process through Kraft, steam-explosion, high-temperature pyrolysis, or other methods, result in long carbon fibers and a high ash content, and often, as in the case of pyrolysis, a condensed material with reduced pores. See, e.g., U.S. Publication 2015/0197424 A1. Lignin produced by solubilization in organic solvents has issues as well and is likely to have low hydrophobicity. Further, there is great expense in producing such lignin. Thus, most lignin residues today are produced in systems and by processes that result in a lignin product that requires much further washing and treatment to be useful for anything but a fuel.

The processes described herein can result in lignin of a uniform small particle size with low sugar, carbohydrate, sulfur and ash content and good hydrophobicity. The acid hydrolysis process used can be much faster and more effective than traditional pretreatment processes, and can remove much of the enzymes, acid, sugars and other residues prior to lignin separation. The sugars can be used to make useful end-products such as biofuels and bioplastics. Further the small particle size of the starting material (ensuring the lignin residues have a small particle size), the removal of the cellulose and hemicellulose, and the amount of residual sugar may contribute to the small pore size and homogeneity in products made using the lignin residues.

Lignin is rich in aromatic rings and contains UV absorbing functional groups. In addition, the chromophores in the lignin structure can make it a natural broad-spectrum sun-blocking entity. Thus, it can have excellent antioxidant properties. Additionally, lignin can increase thermal and oxidation stability of polymers in blends. Further, lignin and lignin blends can have anti-microbial properties. These functionalities may be more concentrated with higher purity lignins.

Lignocellulosic biomass, including wood, can require high temperatures to depolymerize the sugars contained within and, in some cases, explosion and more violent reaction with steam (explosion) and/or acid to make it ready for enzyme hydrolysis. The C5 and C6 sugars, in the form of hemicellulose and cellulose polymers, are naturally embedded in and cross-linked with lignin. The use of high temperature and pressure during pretreatment of lignocellulosic biomass can result in the leaching of lignin, and can also cause buildup of inhibitors and ash. Disclosed herein are processes to pretreat lignocellulosic biomass that can produce a consistent, even lignin product (residue) while reducing the buildup of inhibitors, ash, or a combination thereof. These lignin products can be used for production of polymers and films. They can be especially suited for particular applications that may require a low bulk density and high hydrophobicity.

### Definitions

In this specification and in the claims that follow, reference will be made to a number of terms which shall be defined to have the following meanings.

As used in the specification and the appended claims, the singular forms “a,” “an” and “the” include plural referents unless the context clearly dictates otherwise. Thus, for example, reference to “a purified monomer” includes mixtures of two or more purified monomers. The term “comprising” as used herein is synonymous with “including,” “containing,” or “characterized by,” and is inclusive or open-ended and does not exclude additional, unrecited elements or method steps.

“About” means a referenced numeric indication plus or minus 10% of that referenced numeric indication. For example, the term about 4 would include a range of 3.6 to 4.4. All numbers expressing quantities of ingredients, reaction conditions, and so forth used in the specification are to be understood as being modified in all instances by the term “about.” Accordingly, unless indicated to the contrary, the numerical parameters set forth herein are approximations that can vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Wherever the phrase “for example,” “such as,” “including” and the like are used herein, the phrase “and without limitation” is understood to follow unless explicitly stated otherwise. Therefore, “for example ethanol production” means “for example and without limitation ethanol production”.

“Optional” or “optionally” means that the subsequently described event or circumstance may or may not occur, and that the description includes instances where said event or circumstance occurs and instances where it does not. For example, the phrase “the medium can optionally contain glucose” means that the medium may or may not contain glucose as an ingredient and that the description includes both media containing glucose and media not containing glucose.

Unless characterized otherwise, technical and scientific terms used herein have the same meaning as commonly understood by one of ordinary skill in the art.

“Fermentive end-product” and “fermentation end-product” are used interchangeably herein to include activated carbon, biofuels, chemicals, compounds suitable as liquid fuels, gaseous fuels, triacylglycerols, reagents, chemical feedstocks, chemical additives, processing aids, food additives, bioplastics and precursors to bioplastics, and other products.

The term “lignin” as used herein has its ordinary meaning as known to those skilled in the art and can comprise a cross-linked organic, racemic phenol polymer with molecular masses in excess of 10,000 microns that is relatively hydrophobic and aromatic in nature. Its degree of polymerization in nature can be difficult to measure, at least because it can be fragmented during extraction and the molecule can contain various types of substructures that appear to repeat in a haphazard manner. There are three monolignol monomers, methoxylated to various degrees: p-coumaryl alcohol, coniferyl alcohol, and sinapyl alcohol. These lignols can be incorporated into lignin in the form of the phenylpropanoids p-hydroxyphenyl (H), guaiacyl (G), and syringyl (S), respectively. Lignins can contain small amounts of incomplete or modified monolignols, and other monomers can be prominent in non-woody plants. Lignins can be one of the main classes of structural materials in the support tissues of vascular and nonvascular plants and some algae. Lignins can be particularly important in the formation of cell walls, especially in wood and bark. It is one of the most abundant polymers on earth.

The term “pyrolysis” as used herein has its ordinary meaning as known to those skilled in the art and generally refers to thermal decomposition of a lignocellulosic biomass. In pyrolysis, less oxygen is present than is required for complete combustion, such as less than 10%. In some embodiments, pyrolysis can be performed in the absence of oxygen.

The term “ash” as used herein has its ordinary meaning as known to those skilled in the art and generally refers to any solid residue that remains following a combustion process, and is not limited in its composition. Ash is generally rich in metal oxides, such as SiO₂, CaO, Al₂O₃, and K₂O. “Carbon-containing ash” or “carbonized ash” means ash that has at least some carbon content. Fly ash, also known as flue ash, is one of the residues generated in combustion, and comprises the fine particles that rise with the flue gases. Ash which does not rise is termed bottom ash. Fly ash is generally captured by electrostatic precipitators or other particle filtration equipment before the flue gases are emitted. The bottom ash is typically removed from the bottom of the furnace.

The term “biomass” as used herein has its ordinary meaning as known to those skilled in the art and can include one or more carbonaceous biological materials that can be converted into a biofuel, chemical or other product. Biomass as used herein is synonymous with the term “feedstock” and includes corn syrup, molasses, silage, agricultural residues (corn stalks, grass, straw, grain hulls, bagasse, etc.), animal waste (manure from cattle, poultry, and hogs), Distillers Dried Solubles (DDS), Distillers Dried Grains (DDG), Condensed Distillers Solubles (CDS), Distillers Wet Grains (DWG), Distillers Dried Grains with Solubles (DDGS), woody materials (wood or bark, sawdust, wood chips, timber slash, and mill scrap), municipal waste (waste paper, recycled toilet papers, yard clippings, etc.), and energy crops (poplars, willows, switchgrass, alfalfa, prairie bluestem, algae, including macroalgae, etc.). One exemplary source of biomass is plant matter. Plant matter can be, for example, woody plant matter, non-woody plant matter, cellulosic material, lignocellulosic material, hemicellulosic material, carbohydrates, pectin, starch, inulin, fructans, glucans, corn, sugar cane, grasses, switchgrass, sorghum, high biomass sorghum, bamboo, algae and material derived from these. Plants can be in their natural state or genetically modified, e.g., to increase the cellulosic or hemicellulosic portion of the cell wall, or to produce additional exogenous or endogenous enzymes to increase the separation of cell wall components. Plant matter can be further described by reference to the chemical species present, such as proteins, polysaccharides and oils. Polysaccharides include polymers of various monosaccharides and derivatives of monosaccharides including glucose, fructose, lactose, galacturonic acid, rhamnose, etc. Plant matter also includes agricultural waste byproducts or side streams such as pomace, corn steep liquor, corn steep solids, distillers grains, peels, pits, fermentation waste, straw, lumber, sewage, garbage and food leftovers. Peels can be citrus which include, but are not limited to, tangerine peel, grapefruit peel, orange peel, tangerine peel, lime peel and lemon peel. These materials can come from farms, forestry, industrial sources, households, etc. Another non-limiting example of biomass is animal matter, including, for example milk, meat, fat, animal processing waste, and animal waste. “Feedstock” is frequently used to refer to biomass being used for a process, such as those described herein.

Biomass can be derived from agricultural crops, crop residues, trees, woodchips, sawdust, paper, cardboard, grasses, algae, municipal waste and other sources as described supra. In one embodiment, the biomass contains cellulosic, hemicellulosic, and/or lignocellulosic material. In one embodiment the biomass is woody (poplar, Eucalyptus, willow, pine, etc.). In another embodiment, the biomass is non-woody plant material, such as grasses, dicots, monocots, etc. Other biomasses include algal biomass, nonvascular plant biomass, and processed materials derived from plants; e.g., hulls, distiller's grains, municipal sewage waste, and the like.

In one embodiment, a biomass composition comprising cellulose, hemicellulose, and/or lignocellulose comprises alfalfa, algae, bagasse, bamboo, corn stover, corn cobs, corn fiber, corn kernels, corn mash, corn steep liquor, corn steep solids, distiller's grains, distiller's dried solubles, distiller's dried grains, condensed distiller's solubles, distiller's wet grains, distiller's dried grains with solubles, eucalyptus, food waste, fruit peels, garden residue, grass, grain hulls, modified crop plants, municipal waste, oat hulls, paper, paper pulp, prairie bluestem, poplar, rice hulls, seed hulls, silage, sorghum, straw, sugarcane, switchgrass, wheat, wheat straw, wheat bran, de-starched wheat bran, willows, wood, plant cells, plant tissue cultures, tissue cultures, or a combination thereof.

“Condition” or “conditions” when referring to production of a polyurethane product (e.g., polyurethane foams, plastics, and films) refers to a set of parameters that affect the polymerization reaction resulting in the polyurethane product, including, but not limited to, the species selection of the isocyanate and polyols and their quantities, temperature, pH, pressure, reaction duration, the order of mixing different reactants, mixing speed, the presence or absence of catalysts and additives and their species and quantities.

“Concentration” when referring to material in the broth or in solution generally refers to the amount of a material present from all sources, whether made by the organism or added to the broth or solution. Concentration can refer to soluble species or insoluble species, and is referenced to either the liquid portion of the broth or the total volume of the broth, as for “titer.” When referring to a solution, such as “concentration of the sugar in solution”, the term indicates increasing one or more components of the solution through evaporation, filtering, extraction, etc., by removal or reduction of a liquid portion.

“Pretreatment” or “pretreated” is used herein to refer to any mechanical, chemical, thermal, biochemical process or combination of these processes whether in a combined step or performed sequentially, that achieves disruption or expansion of the biomass so as to render the biomass more susceptible to attack by enzymes and/or microbes. In one embodiment, pretreatment includes removal or disruption of lignin so as to make the cellulose and hemicellulose polymers in the plant biomass more available to cellulolytic enzymes and/or microbes, for example, by treatment with acid or base. In one embodiment, pretreatment includes disruption or expansion of cellulosic and/or hemicellulosic material. Chemical pretreatment processes include, but are not limited to, bleaching, oxidation, reduction, acid treatment, base treatment, sulfite treatment, acid sulfite treatment, basic sulfite treatment, ammonia treatment, and hydrolysis. Thermal pretreatment processes include, but are not limited to, sterilization, ammonia fiber expansion or explosion (“AFEX”), steam explosion, holding at elevated temperatures, pressurized or unpressurized, in the presence or absence of water, and freezing. Biochemical processes include, but are not limited to, treatment with enzymes, including enzymes produced by genetically-modified plants, and treatment with microorganisms. Various enzymes that can be utilized include cellulase, amylase, β-glucosidase, xylanase, gluconase, and other polysaccharases; lysozyme; laccase, and other lignin-modifying enzymes; lipoxygenase, peroxidase, and other oxidative enzymes; proteases; and lipases. One or more of the mechanical, chemical, thermal, thermochemical, and biochemical processes can be combined or used separately. Such combined processes can also include those used in the production of paper, cellulose products, microcrystalline cellulose, and cellulosics and can include pulping, Kraft pulping, acidic sulfite processing. The feedstock can be a side stream or waste stream from a facility that utilizes one or more of these processes on a biomass material, such as cellulosic, hemicellulosic or lignocellulosic material. Examples include paper plants, cellulosics plants, distillation plants, cotton processing plants, and microcrystalline cellulose plants. The feedstock can also include cellulose-containing or cellulosic containing waste materials. The feedstock can also be biomass materials, such as wood, grasses, corn, starch, or saccharide, produced or harvested as an intended feedstock for production of ethanol or other products such as by biocatalysts.

Pretreatment of the biomass composition can be performed such that any solids are reduced in size. Reducing the size of solids in the biomass composition can be advantageous because smaller particles have larger surface area to volume ratios. Increasing the ratio of surface area to volume can be advantageous because it can, for example, increase the rate of particle wetting (e.g., with water or a chemical agent such as an acid or a base), increase the accessibility of enzymes to the polysaccharides in the biomass, enable the use of a smaller dose of enzymes during a hydrolysis of the biomass, enable the use of fewer or lower amounts of chemicals (e.g., acids or bases) during a pretreatment and/or hydrolysis step, enable the use of weaker acids or bases in a pretreatment or hydrolysis step, enable the use of higher concentrations of solids in any further processing step (e.g., during a hydrolysis step), and/or increase the yield of saccharides from the hydrolysis of the biomass.

Biomass compositions can be reduced in size to a mixture of particles having a uniform, or substantially uniform, size. Such mixtures can be referred to as homogeneous mixtures. Homogeneous mixtures of particles can have many advantages over mixtures of particles having heterogeneous sizes with respect to further pretreatment processes and/or during hydrolysis to produce saccharide streams. For example, heterogeneous mixtures of particles can experience uneven heating during thermal and thermochemical processing steps. Uneven heating can lead to overcooking (e.g., charring/burning) of particles and/or undercooking of particles. Charring or burning of particles can reduce the yield of saccharide from the hydrolysis of the particles; this can be due to degradation or denaturation of saccharide polymers such as starch, hemicellulose, and/or cellulose. Undercooking of particles can lead to unhydrolyzed saccharide polymers (e.g., starch, hemicellulose, cellulose) during enzymatic or chemical hydrolysis, which can also reduce the yield of saccharide. In contrast, uniform heating, wetting, chemical treatment (e.g., acid or base treatment), and/or enzyme hydrolysis can be achieved with mixtures of particles having uniform sizes (e.g., homogeneous mixtures).

“Sugar compounds”, “sugar streams”, “saccharide compounds”, or “saccharide streams” is used herein to indicate mostly monosaccharide sugars, dissolved, crystallized, evaporated, or partially dissolved, including, but not limited to, hexoses and pentoses; sugar alcohols; sugar acids; sugar amines; compounds containing two or more of these linked together directly or indirectly through covalent or ionic bonds; and mixtures thereof. Included within this description are disaccharides; trisaccharides; oligosaccharides; polysaccharides; and sugar chains, branched and/or linear, of any length. A sugar stream can consist of primarily or substantially C6 sugars, C5 sugars, or mixtures of both C6 and C5 sugars in varying ratios of said sugars. C6 sugars have a six-carbon molecular backbone and C5 sugars have a five-carbon molecular backbone. The terms “sugar” and “saccharide” are used interchangeably herein.

A “liquid” composition may contain solids and a “solids” composition may contain liquids. A liquid composition refers to a composition in which the material is primarily liquid, and a solids composition is one in which the material is primarily solid.

The term “fatty acid” refers to a carboxylic acid with an aliphatic tail which may be saturated or unsaturated. The term includes short chain fatty acids (2-5 carbon aliphatic tail), medium chain fatty acids (6-12 carbon aliphatic tail), long chain fatty acids (13-21 carbon aliphatic tail), very long chain fatty acids (22 or greater carbon aliphatic tail), fatty acid of phosphatidylethanolamine, a fatty acid of soybean lecithin, or an unsaturated fatty acid of egg lecithin.

The term “kPa” refers to kilopascal, a unit of pressure. Standard atmospheric pressure, the pressure exerted by a 10 g mass resting on a 1 cm² area, is defined as 101.325 kPa. The term “psi” or “PSI” refers to pound-force per square inch. It is the pressure resulting from a force of one pound-force applied to an area of one square inch.

The term “polymer” may be a natural, a semisynthetic polymer, or a synthetic polymer. Examples of such polymers include, but not limited to, albumins, aliginic acids, carboxymethylcelluloses, sodium salt cross-linked, celluloses, cellulose acetates, cellulose acetate butyrates, cellulose acetate phthalates, cellulose acetate trimelliates, chitins, chitosans, collagens, dextrins, ethylcelluloses, gelatins, guargums, hydroxypropylmethyl celluloses (HPC), karana gums, methyl celluloses, poloxamers, polysaccharides, lignin, silk protein, sodium starch glycolates, starch thermally modifieds, tragacanth gums, and xanthangum polysaccharides.

Examples of synthetic polymers include, but not limited to, cellophane (polyethylene-coated), monomethoxypolyethylene glycols (mPEG), nylons, polyacetals, polyacrylates, poly(alkylene oxides), polyamides, polyamines, polyanhydrides, polyargines, polybutylene oxides (PBO), polybutyolactones, polycaprolactones (PCL), polycarbonates, polycyanoacrylates, poly(dioxanones) (PDO), polyesters, polyethers, polyethylenes, poly(ethylene-propylene) copolymers, poly(ethylene glycols) (PEG), poly(ethylene imines), polyethylene oxides (PEO), polyglycolides (PGA), polyhydroxyacids, polylactides (PLA), polylysines, polymethacrylates (PMA), poly(methyl vinyl ethers) (PMV), poly(N-vinylpyrrolidinones) (NVP), polyornithines, poly(orthoesters) (POE), polyphosphazenes, polypropiolactones, polypropylenes, poly(propylene glycols) (PPG), polypropylene oxides (PPO), polypropylfumerates, polyserines, polystyrenes, polyureas, polyurethanes, polyvinyl alcohols (PVA), poly(vinyl chlorides) (PVC), poly (vinyl pyrrolidines), silicon rubbers, and blends thereof.

The polymer can be a homopolymer, a copolymer, a block copolymer with monomers from one or more the polymers above. If the polymer comprises asymmetric monomers, it may be regio-regular, isotactic or syndiotactic (alternating); or region-random, atactic. If the polymer comprises chiral monomers, the polymer may be stereo-regular or a racemic mixture, e.g., poly(D-, L-lactic acid). It may be a random copolymer, an alternating copolymer, a periodic copolymer, e.g., repeating units with a formula such as [AₙBₘ]. The polymer can be a linear polymer, a ring polymer, a branched polymer, e.g., a dendrimer. The polymer may or may not be cross-linked. The polymer can be a block copolymer comprising a hydrophilic block polymer and a hydrophobic block polymer.

The polymer can comprise derivatives of individual monomers chemically modified with substituents, including without limitation, alkylation, e.g., (poly C₁-C₁₆ alkyl methacrylate), amidation, esterification, ether, or salt formation. The polymer can also be modified by specific covalent attachments the backbone (main chain modification) or ends of the polymer (end group modifications). Examples of such modifications include without limitation attaching PEG (PEGylation) or albumin.

In certain embodiments, the polymer can be a poly(dioxanone). The poly(dioxanone) can be poly(p-dioxanone), see U.S. Pat. Nos. 4,052,988; 4,643,191; 5,080,665; and 5,019,094, the contents of which are hereby incorporated by reference in their entirety. The polymer can be a copolymer of poly(alkylene oxide) and poly(p-dioxanone), such as a block copolymer of poly(ethylene glycol) (PEG) and poly(p-dioxanone) which may or may not include PLA, see U.S. Pat. No. 6,599,519, the content of which is hereby incorporated by reference in its entirety.

In some embodiments, the polymer can be a polyethylene oxide (PEO). Examples of PEO block copolymers include U.S. Pat. Nos. 5,612,052 and 5,702,717, the contents of which are hereby incorporated by reference in their entirety. In some embodiments, a polymeric matrix can be a polylactide (PLA), including poly(L-lactic acid), poly(D-lactic acid), poly(D-,L-lactic acid); a polyglycolide (PGA); poly(lactic-co-glycolic acid) (PLGA); poly (lactic-co-dioxanone) (PLDO) which may or may not include polyethylene glycol (PEG). See U.S. Pat. Nos. 4,862,168; 4,452,973; 4,716,203; 4,942,035; 5,384,333; 5,449,513; 5,476,909; 5,510,103; 5,543,158; 5,548,035; 5,683,723; 5,702,717; 6,616,941; 6,916,788, PLA-PEG, PLDO-PEG, PLGA-PEG), U.S. Pat. No. 7,217,770 (PEG-PLA); U.S. Pat. No. 7,311,901 (amphophilic copolymers); U.S. Pat. No. 7,550,157 (mPEG-PCL, mPEG-PLA, mPEG-PLDO, mPEG-PLGA, and micelles); U.S. Pat. Pub. No. 2010/0008998 (PEG2000/4000/10,000-mPEG-PLA); PCT Pub. No. 2009/084801 (mPEG-PLA and mPEG-PLGA micelles), the contents of which are hereby incorporated by reference in their entirety. In some embodiments, a polymer comprises lignins, proteins, lipids, surfactants, carbohydrates, small molecules, and/or polynucleotides.

### DESCRIPTION

Extrusion can mean the process of forcing a material through a specifically designed opening. For food processing and other types of processing materials, the principle of screw extruders is similar. They can employ low shear, deep-flight screws and operate a low screw speeds, for cooking, mixing, and forming materials, and for other appropriate purposes.

Modern extruders can comprise a basic drive assembly that is then outfitted with combinations of modular preconditioners, screw worms, barrel sections, dies and cutters to obtain the desired shearing, heating/cooling, and product shaping effects desired. They can comprise single, twin, and triple screws, depending on the application for which they are constructed. The operating costs for these systems can be low compared to their output, because of reduced capital costs as well as increased energy efficiency.

The turning screws can ensure that all of the material has contact with the same pressure, temperature and chemical reagents, unlike kilns and barrels wherein the material on the outside is subject to higher temperatures than that on the inside and wherein the chemical mixing is heterogeneous. See, e.g., U.S. Pat. Nos. 7,029,273 B2, 8,309,052 B2, and PCT patent application No. WO2016/094594 A1, each of which is incorporated by reference in its entirety. A heat jacket can be provided on the extruder, for example, to maintain temperature within the barrel. Jets can be provided to inject steam and chemicals as the materials are being mixed. A further advantage can be the speed of the process, which can occur, for example, in seconds and minutes. Extruders can also enable continuous processing, rather than a batch processing, of materials.

Lignocellulosic biomass can be distributed in the reaction zone of an extruder in a uniform manner, and the pretreatment reaction can take place with temperature, pressure and chemical treatment applied consistently throughout the material, such that the total duration of the treatment of the material can be reduced and the reactions are complete evenly throughout the material. This can increase the yield of desired products. This can also reduce the yield of inhibitors and/or ash.

Lignocellulosic materials useful for this process can include, for example, wood, sawdust, wood chips, vegetable or animal matter, plant residues, and plant and animal waste residues from plants and animal matter, respectively, that have been processed to extract chemical compounds such as proteins, carbohydrates, and minerals. In another embodiment, municipal solid waste can be used in this process. In a further embodiment, the lignocellulosic biomass can be selected from: timber harvesting residues, softwood chips, hardwood chips, tree branches, stumps, leaves, off-spec paper pulp, cellulose, corn, corn fiber, corncobs, sorghum, corn stover, wheat straw, rice straw, sugarcane bagasse, algae, switchgrass, miscanthus, animal manure, municipal garbage municipal sewage, commercial waste grape pumice, vinasse, nuts, nut shells, coconut shells, coffee grounds, grass pellets, hay pellets, wood pellets, cardboard, paper, carbohydrates, and cloth. A person of ordinary skill in the art will readily appreciate that the feedstock options are virtually unlimited.

Steam explosion and/or acid hydrolysis of lignocellulosic biomass to produce sugars can be costly and require special equipment. The process, especially under high temperature and pressure, can release structural carbohydrates in cellulosic biomass and can expose crystalline cellulose to enzymatic degradation. The byproducts of acid hydrolysis and subsequent enzymatic hydrolysis and fermentation can be a solids mixture of unfermented carbohydrate, lignin, protein and minerals, often called “lignin residues”. On a dry weight basis, using an extruder with controls as described herein and enzymatic hydrolysis, the carbohydrate portion can vary from 1-30% but is normally less than 15%. The protein component can range from 1-5% and minerals (ash) can comprise from 0.1-4%. There can also be some remaining enzymes in the mixture. However, the largest component is typically lignin, which can range from 30-95%, depending on the type of biomass and which has already been solubilized.

The lignin produced by the processes described above can be very clean, hydrophobic, and of a very small, uniform particle size, making it an excellent starting material for polymer foams and films.

Lignocellulosic Material Handling

Mechanical processes can include, but are not limited to, washing, soaking, milling, grinding, size reduction, screening, shearing, size classification and density classification processes. Chemical processes can include, but are not limited to, bleaching, oxidation, reduction, acid treatment, base treatment, sulfite treatment, acid sulfite treatment, basic sulfite treatment, ammonia treatment, and hydrolysis. Thermal processes can include, but are not limited to, sterilization, ammonia fiber expansion or explosion (“AFEX”), steam explosion, holding at elevated temperatures, pressurized or unpressurized, in the presence or absence of water, and freezing. Biochemical processes can include, but are not limited to, treatment with enzymes, including enzymes produced by genetically-modified plants, and treatment with microorganisms. Various enzymes that can be utilized include cellulase, amylase, β-glucosidase, xylanase, gluconase, and other polysaccharases; lysozyme; laccase, and other lignin-modifying enzymes; lipoxygenase, peroxidase, and other oxidative enzymes; proteases; and lipases. One or more of the mechanical, chemical, thermal, thermochemical, and biochemical processes can be combined or used separately. The feedstock can be a side stream or waste stream from a facility that utilizes one or more of these processes on a biomass material, such as cellulosic, hemicellulosic or lignocellulosic material. Examples can include paper plants, cellulosics plants, distillation plants, cotton processing plants, and microcrystalline cellulose plants. The feedstock can also include cellulose-containing or cellulosic containing waste materials. The feedstock can also be biomass materials, such as wood, grasses, corn, starch, or sugar, produced or harvested as an intended feedstock for production of ethanol or other products such as by biocatalysts.

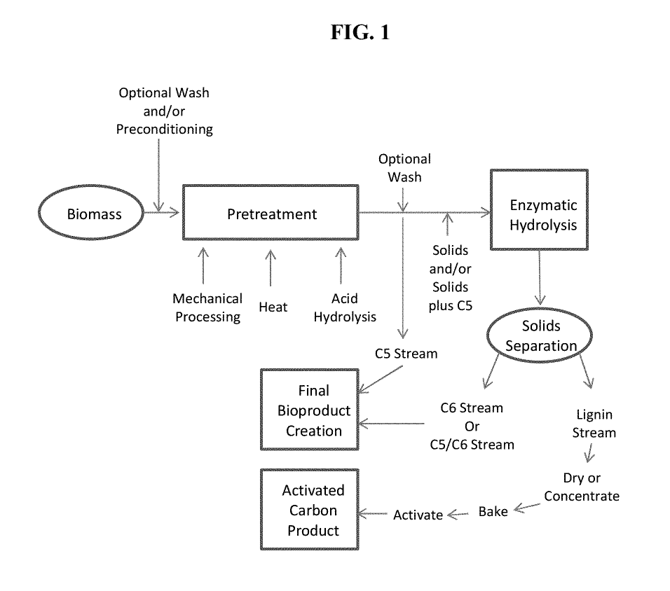

An exemplary system that produces lignin residues is illustrated in FIG. 1. This system can hydrolyze plant matter via steam, pressure, and high temperature, and can additionally use acid to convert carbohydrate polymers to monomers and oligomers. Further hydrolysis and bioproduct formation (products such as ethanol, other biofuels, and bioplastics or biochemicals) can be accomplished through enzymes, microorganisms, or both. The residual matter left from this process is very high in lignin. Lignin in these residues can be separated out by further processing if necessary.

In some embodiments, the movement of the lignocellulosic material through reactors uses plugs to chamber different reactions and to reduce particle size. These embodiments can be varied to accommodate different types and sizes of lignocellulosic biomass for optimal processing and the recovery of very clean lignin residues. For example, the formation of plugs can be reduced or eliminated if required. Or, if a longer activation time is desired, the area between the plugs for pretreatment can be lengthened. Residence time in any chamber can also be varied depending on the intended application. Those of skill in the art will understand that the types of screw sections that produce the plugs, and cut and move the processing materials forward and their placement can all be varied and optimized depending on the intended application.

The lignocellulosic biomass can be loaded into a feeder apparatus which feeds it to the reactor. The loading can be facilitated by use of a flow conveyor such as a screw conveyor, drag chain, bucket elevator, conveyor belt, or the like. The feeding of the lignocellulosic biomass into the reactor can be made more uniform by the addition of a conical screw or the like, that can allow the lignocellulosic biomass to enter the reactor at a uniform rate and density. This can help to keep the feeder apparatus from clogging.

Using this method, an aqueous solution comprising acid or base can be applied that comprises any concentration that is necessary to pretreat the biomass. Thus, for example, acid at a concentration of 0.01% to over 7 or 8%, or concentrations of 1%, 2%, 3%, 4%, 5%, 6% or anything in between or higher can be used. In extruder devices, ports, excluding the one or more through which steam or gas is being added, can be sealed. Valves for use in the devices as provided herein can be any type of valve known in the art that can be opened or closed. The valves can be ball valves, poppet-valves, check valves, or rotating knife-gate valves, or combinations thereof. See, e.g., PCT publ. WO 2016/094594A1, which is hereby incorporated by reference in its entirety.

Steam or gas can be added through one or more ports in the cylindrical barrel at the beginning of the reaction zone, after the first plug is formed, in an amount that is needed to raise the temperature of the lignocellulosic biomass mixture to the desired point. More than one port can be used, with ports being spaced so that steam or gas contact is distributed over the lignocellulosic biomass or to raise the temperature and pressure more quickly. Pressurized steam or gas can be added to raise the temperature of the lignocellulosic biomass and potential aqueous acid or base mixture to between about 80° C. and about 300° C., preferably between 160° C. and 300° C. The temperature of the biomass and aqueous acid or base can be more than 20° C., 25° C., 30° C., 35° C., 40° C., 45° C., 50° C., 55° C., 60° C., 65° C., 80° C., 90° C., 100° C., 120° C., 150° C., 200° C., 250° C., 300° C., 350° C., or 400° C. The temperature of the lignocellulosic biomass and aqueous acid or base can be about 20° C., 25° C., 30° C., 35° C., 40° C., 45° C., 50° C., 55° C., 60° C., 65° C., 80° C., 90° C., 100° C., 120° C., 150° C., 200° C., 250° C., 300° C., 350° C., or 400° C. The temperature of the biomass and aqueous acid or base can be from about 20° C. to about 400° C., about 50° C. to about 350° C., about 80° C. to about 300° C., about 100° C. to about 250° C., or about 160° C. to about 210° C.

Additional steam or gas can be added through ports between the plug formation of the cylindrical chamber, if needed to maintain the desired temperature and pressure. The apparatus can include a heating jacket, steam jacket, band heaters, barrel heaters, or insulation jacket to contribute to raising and/or maintaining the temperature and pressure. Heating or steam jackets can be suited to small scale reactors while insulation jackets can be suited to large scale reactors. Heating can occur at different stages, including preheating the barrel prior to treating or pretreating. The type of lignocellulosic biomass being treated also can affect the optimum time and temperature for treatment in the present method, as can readily be assessed by one skilled in the art.

Bringing the lignocellulosic biomass to the described temperatures using pressurized steam in these methods can result in pressures within the reactor chamber that are between about 160 PSI and about 1200 PSI. More typically, pressure can be between about 300 PSI to 800 PSI. The pressurized steam can be added through the ports at about 400 to 600 PSI. The pressures within the reactor chamber can be 25-250 PSI, 25-225 PSI, 25-200 PSI, 25-175 PSI, 25-150 PSI, 25-125 PSI, 25-100 PSI, 25-75 PSI, 25-50 PSI, 50-225 PSI, 50-200 PSI, 50-175 PSI, 50-150 PSI, 50-125 PSI, 50-100 PSI, 50-75 PSI, 75-200 PSI, 75-175 PSI, 75-150 PSI, 75-125 PSI, 75-100 PSI, 100-175 PSI, 100-150 PSI, 100-125 PSI, 125-150 PSI, 25 PSI, 30 PSI, 35 PSI, 40 PSI, 45 PSI, 50 PSI, 55 PSI, 60 PSI, 65 PSI, 70 PSI, 75 PSI, 80 PSI, 85 PSI, 90 PSI, 95 PSI, 100 PSI, 105 PSI, 110 PSI, 115 PSI, 120 PSI, 125 PSI, 130 PSI, 135 PSI, 140 PSI, 145 PSI, 150 PSI, 155 PSI, 160 PSI, 165 PSI, 170 PSI, 175 PSI, 180 PSI, 185 PSI, 190 PSI, 195 PSI, 200 PSI, 205 PSI, 210 PSI, 215 PSI, 220 PSI, 225 PSI, 230 PSI, 235 PSI, 240 PSI, 245 PSI, 250 PSI, 300 psi, 350 PSI, 400 PSI, 450 PSI, 500 PSI, 550 PSI, 600 PS, 650 PSI, 700 PSI, 750 PSI, 800 PSI, 850 PSI, 900 PSI, 950 PSI, 1000 or 1200 PSI. However, under certain circumstances a lower pressure can be desirable.

Biomass Processing Plant and Process of Producing Lignin from Biomass

Generally, there are several basic approaches to producing lignin, fuels and chemical end-products from biomass on a large scale utilizing microbial cells. In a first method, one first pretreats and hydrolyzes a biomass material that includes high molecular weight carbohydrates to lower molecular weight carbohydrates, and then separates the lower molecular weight carbohydrates from the lignin residues and the lower molecular weight carbohydrates are fermented utilizing microbial cells to produce fuel or other products, leaving a high concentration of lignin residues. In the second method, one treats the biomass material itself using mechanical, chemical and/or enzymatic methods. In all methods, depending on the type of biomass and its physical manifestation, one of the processes can comprise a milling of the lignocellulosic biomass, via wet or dry milling, to reduce the material in size and increase the surface to volume ratio (physical modification).

The lignin residues can also be concentrated by any means, such as drying, evaporation, flocculation, filtration, centrifugation or a combination of these methods. They can be dried and can be shaped into pellets, bricks, or any desirable shape. In one embodiment, the lignin residues can be crumbled or ground into a powder.

In some embodiments, provided is a system comprising a pretreatment unit, configured to pretreat a biomass by at least one of mechanical processing, heat, acid hydrolysis, or any combination thereof, and an enzymatic hydrolysis unit configured to hydrolyze saccharide polymers to saccharide monomers and oligomers, a separation unit configured to separate a product of enzymatic hydrolysis from lignin residues, and then a unit for conversion of the lignin residues to a product such as a polyurethane polymer or a UV resistant film.

In some embodiments, the pretreatment unit consists in part of an extruder.

In general, an extruder for use in this system includes an elongated barrel presenting a material inlet and a material outlet adjacent opposed ends thereof, with one or more elongated, axially rotatable screw(s) within the barrel which serves to advance the material from the inlet end to the outlet end thereof. The screw is designed to smooth the flow of material while reducing it in size and various screw elements are arranged to increase or decrease the flow, or to form plugs of the biomass within the barrel. The screw(s) coupled with an end valve under pressure at the outlet, control the speed, pressure, and partly the temperature applied to the biomass as it moves through and out of the barrel.

The residence time in the reaction zone can be very short as compared to other pretreatment systems known in the art. The residence time in a reaction zone of a device as provided herein can be less than 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 35, 40, 45, 50, 55, or 60 seconds. The residence time in a reaction zone of a device as provided herein can be about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 35, 40, 45, 50, 55, or 60 seconds. The residence time in a reaction zone of a device as provided herein can be between about 1 second to about 2, about 1 second to about 3 seconds, about 1 second to about 4 seconds, about 1 second to about 5 seconds, about 1 second to about 6 seconds, about 1 second to about 7 seconds, about 1 second to about 8 seconds, about 1 second to about 9 seconds, about 1 second to about 10 seconds, about 1 second to about 15 seconds, about 1 to about 20 seconds, about 2 second to about 4 seconds, about 2 second, to about 6 second, about 2 seconds to about 8 second, about 2 second, to about 10 seconds, about 2 seconds to about 15 second, about 2 seconds to about 20 seconds, about 5 seconds to about 10 seconds, about 5 seconds to about 10 seconds, about 5 seconds to about 15 seconds, about 5 seconds to about 20 seconds, about 10 second to about 12 second seconds, about 10 seconds to about 14 seconds, about 10 seconds, to about 16 seconds, about 10 seconds to about 18 seconds, about 10 seconds to about 20 seconds, about 15 seconds to about 20 seconds, about 20 seconds to about 30 seconds, about 30 seconds to about 45 seconds, or about 45 seconds to about 60 seconds. The pressure can vary from 0 to 800 PSI, preferably from 300-700 PSI. The temperature range is wide, from 100 to 260° C. or more, preferably from 160-230° C. The temperature used often depends on the crystallinity of the cellulose fiber in the biomass; for example, softwood has a higher percent of crystalline cellulose and requires a temperature of 210-240° C. Acid may or may not be added to assist with the reaction and can range from 0 wt % of pure chemical per dry tonne of biomass to 8 wt % of pure chemical per dry tonne of biomass, preferably from 1 wt % to 5 wt %.

In another embodiment, biomass as provided herein can be pre-treated at an elevated temperature and/or pressure in a device as provided herein. In one embodiment, biomass is pre-treated at a temperature range of 20° C. to 400° C. In another embodiment biomass is pretreated at a temperature of about 20° C., 25° C., 30° C., 35° C., 40° C., 45° C., 50° C., 55° C., 60° C., 65° C., 80° C., 90° C., 100° C., 120° C., 150° C., 200° C., 250° C., 300° C., 350° C., 400° C. or higher. In another embodiment, elevated temperatures are provided by the use of steam, hot water, or hot gases. In one embodiment steam can be injected into a biomass containing vessel or barrel chamber. In another embodiment the steam, hot water, or hot gas can be injected into a vessel jacket such that it heats, but does not directly contact the biomass. In an additional embodiment heat can be externally applied using electric barrel heaters.

In another embodiment, biomass as provided herein can be pre-treated at an elevated temperature and/or pressure in a device as provided herein. In one embodiment, biomass is pre-treated at a pressure range of from 0 to 800 PSI. In some embodiments, heating the biomass pretreated in a device as provided herein is performed at a pressure higher than atmospheric. The pressure can be from about 25 PSI to about 800 PSI. The pressure can be from about 300 PSI and 500 PSI. The pressure can be about 400 PSI. For example, the pressure can be about 25-800, 25-700, 25-600, 25-500, 25-250 PSI, 25-225 PSI, 25-200 PSI, 25-175 PSI, 25-150 PSI, 25-125 PSI, 25-100 PSI, 25-75 PSI, 25-50 PSI, 50-225 PSI, 50-200 PSI, 50-175 PSI, 50-150 PSI, 50-125 PSI, 50-100 PSI, 50-75 PSI, 75-200 PSI, 75-175 PSI, 75-150 PSI, 75-125 PSI, 75-100 PSI, 100-175 PSI, 100-150 PSI, 100-125 PSI, 125-150 PSI, 25 PSI, 30 PSI, 35 PSI, 40 PSI, 45 PSI, 50 PSI, 55 PSI, 60 PSI, 65 PSI, 70 PSI, 75 PSI, 80 PSI, 85 PSI, 90 PSI, 95 PSI, 100 PSI, 105 PSI, 110 PSI, 115 PSI, 120 PSI, 125 PSI, 130 PSI, 135 PSI, 140 PSI, 145 PSI, 150 PSI, 155 PSI, 160 PSI, 165 PSI, 170 PSI, 175 PSI, 180 PSI, 185 PSI, 190 PSI, 195 PSI, 200 PSI, 205 PSI, 210 PSI, 215 PSI, 220 PSI, 225 PSI, 230 PSI, 235 PSI, 240 PSI, 245 PSI, 250 PSI, 300 PSI, 350 PSI, 400 PSI, 450 PSI, 500 PSI, 550 PSI, 600 PS, 650 PSI, 700 PSI, 750 PSI, 800 PSI, 850 PSI, 900 PSI, 950 PSI, or 1000 PSI. In one embodiment, the pressure is from about 25 PSI to about 250 PSI. In another embodiment, the pressure is from about 75 PSI to about 200 PSI. In another embodiment, the pressure is from about 100 PSI to about 400 PSI.

In one embodiment, one or more acids can be combined, resulting in a buffer that can be used for conducting pretreatment of biomass as provided herein in a device as provided herein. In some instances, the pH can be lowered to neutral pH or acidic pH, for example a pH of 7.0, 6.5, 6.0, 5.5, 5.0, 4.5, 4.0, or lower. For example, the non-neutral aqueous medium used to pretreat biomass as provided herein in a device as provided herein can have a pH that is less than 7, 6.5, 6, 5.5, 5, 4.5, 4, 3.5, 3, 2.5, 2, 1.5, or 1. For example, the non-neutral aqueous medium can have a pH that is about 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, 0.1, or lower. In some embodiments, the pH is lowered and/or maintained within a range of about pH 4.5 to about 7.1, or about 4.5 to about 6.9, or about pH 5.0 to about 6.3, or about pH 5.5 to about 6.3, or about pH 6.0 to about 6.5, or about pH 5.5 to about 6.9 or about pH 6.2 to about 6.7.

In some embodiments, pretreatment of a biomass as provided herein in a device as provided herein comprises hydration of the biomass composition in a non-neutral aqueous medium having a pH that is greater than 7. For example, the non-neutral aqueous medium can have a pH that is greater than 7, 7.5, 8, 8.5, 9, 9.5, 10, 10.5, 11, 11.5, 12, 12.5, 13, 13.5 or higher. For example, the non-neutral aqueous medium can have a pH that is about 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, 13.9, or higher. The non-neutral aqueous medium having a pH greater than 7 can comprise one or more bases such as sodium hydroxide, calcium hydroxide, potassium hydroxide, ammonia, ammonia hydroxide, hydrogen peroxide or a combination thereof. The one or more bases can be at any suitable concentration, such as any of the concentrations disclosed herein.

In some embodiments, pretreatment of a biomass composition comprises hydration of the biomass composition in a non-neutral aqueous medium comprises from about 0.1% to about 50% w/w or v/w by dry biomass weight of one or more acids or one or more bases. For example, the non-neutral aqueous medium can comprise about 25-50%, 10-50%, 10-25%, 5-50%, 5-25%, 5-10%, 4-50%, 4-25%, 4-10%, 4-5%, 3-50%, 3-25%, 3-10%, 3-5%, 3-4%, 2-50%, 2-25%, 2-10%, 2-5%, 2-4%, 2-3%, 1-50%, 1-25%, 1-10%, 1-5%, 1-4%, 1-3%, 1-2%, 0.5-50%, 0.5-25%, 0.5-10%, 0.5-5%, 0.5-4%, 0.5-3%, 0.5-2%, 0.5-1%, 0.5-%, 0.1-50%, 0.1-25%, 0.1-10%, 0.1-5%, 0.1-4%, 0.1-3%, 0.1-2%, 0.1-1%, 0.1-0.5%, 50%, 45%, 40%, 35%, 30%, 25%, 24%, 23%, 22%, 21%, 20%, 19%, 18%, 17%, 16%, 15%, 14%, 13%, 12%, 11%, 10%, 9.5%, 9%, 8.5%, 8%, 7.5%, 7%, 6.5%, 6%, 5.5%, 5%, 4.9%, 4.8%, 4.7%, 4.6%, 4.5%, 4.4%, 4.3%, 4.2%, 4.1%, 4%, 3.9%, 3.8%, 3.7%, 3.6%, 3.5%, 3.4%, 3.3%, 3.2%, 3.1%, 3%, 2.9%, 2.8%, 2.7%, 2.6%, 2.5%, 2.4%, 2.3%, 2.2%, 2.1%, 2%, 1.9%, 1.8%, 1.7%, 1.6%, 1.5%, 1.4%, 1.3%, 1.2%, 1.1%, 1%, 0.9%, 0.8%, 0.7%, 0.6%, 0.5%, 0.4%, 0.3%, 0.2%, or 0.1% of the one or more acids or the one or more bases. The one or more acids can be sulfuric acid, peroxyacetic acid, lactic acid, formic acid, acetic acid, citric acid, phosphoric acid, hydrochloric acid, sulfurous acid, chloroacetic acid, dichloroacetic acid, trichloroacetic acid, trifluoroacetic acid, oxalic acid, benzoic acid, or a combination thereof. The one or more bases can be sodium hydroxide, calcium hydroxide, potassium hydroxide, ammonia, ammonia hydroxide, hydrogen peroxide or a combination thereof. In some embodiments, the non-neutral aqueous medium comprises the one or more acids or the one or more bases at from about 1% to about 5% v/w by dry biomass weight. In some embodiments, the non-neutral aqueous medium comprises sulfuric acid at from about 1% to about 5% v/w by dry biomass weight. In some embodiments, the non-neutral aqueous medium comprises sulfuric acid at about 1.8% v/w by dry biomass weight. In some embodiments, the non-neutral aqueous medium comprises sulfuric acid at about 1% v/w by dry biomass weight.

In some embodiments, the system further comprises, upstream of the pretreatment unit, a washing unit configured to wash or precondition a biomass before the biomass is fed to the pretreatment unit.

In some embodiments, the system further comprises, upstream of the hydrolysis unit and downstream of the pretreatment unit, a washing unit configured to wash pretreated biomass before the pretreated biomass is fed to the hydrolysis unit.

In some embodiments, the system comprises an additional unit to remove the C5 sugars from the pretreatment, prior to hydrolyzing the cellulosic materials in the biomass.

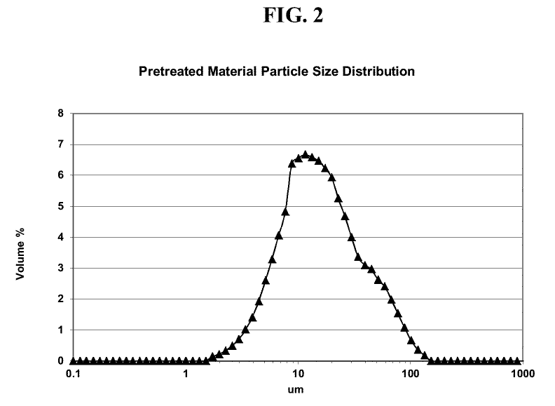

According to one exemplary embodiment, particle size distribution of the residue from the extruder pretreatment is shown in FIG. 2. The particle size of lignin following further enzymatic hydrolysis to remove carbohydrate can be even smaller so that some of the lignin product can be easily solubilized in solutions. Other lignins, such as those produced from Kraft processes, lignosulfonates, and acid and alkali barrel-type produced lignins are less uniform and not as clean due to the harshness of the processes by which they are produced and/or the disproportionate size of the lignin particles that are in the residues. This can result in extra expense to clean and modify the residues, or the products can have less strength and may be unsuitable for their purpose.

### Enzymatic Hydrolysis

In one embodiment, enzyme treatment is used to hydrolyze various higher saccharides (higher molecular weight) present in biomass to lower saccharides (lower molecular weight), such as in preparation for fermentation by biocatalysts such as yeasts to produce ethanol, hydrogen, or other chemicals such as organic acids including succinic acid, formic acid, acetic acid, and lactic acid. These enzymes and/or the hydrolysate can be used in fermentations to produce various products including fuels, and other chemicals.

In one example, the process for converting biomass material into ethanol includes pretreating the biomass material (e.g., “feedstock”), hydrolyzing the pretreated biomass to convert polysaccharides to oligosaccharides, further hydrolyzing the oligosaccharides to monosaccharides, and converting the monosaccharides to biofuels and chemical products. Enzymes such as cellulases, polysaccharases, lipases, proteases, ligninases, and hemicellulases, help produce the monosaccharides can be used in the biosynthesis of fermentation end-products. Biomass material that can be utilized includes woody plant matter, non-woody plant matter, cellulosic material, lignocellulosic material, hemicellulosic material, carbohydrates, pectin, starch, inulin, fructans, glucans, corn, algae, sugarcane, other grasses, switchgrass, bagasse, wheat straw, barley straw, rice straw, corncobs, bamboo, citrus peels, sorghum, high biomass sorghum, seed hulls, and material derived from these. The final product can then be separated and/or purified, as indicated by the properties for the desired final product. In some instances, compounds related to sugars such as sugar alcohols or sugar acids can be utilized as well.

Chemicals used in the methods of the present invention are readily available and can be purchased from a commercial supplier, such as Sigma-Aldrich. Additionally, commercial enzyme cocktails (e.g. Accellerase™ 1000, CelluSeb-TL, CelluSeb-TS, Cellic™, CTec, STARGEN™, Maxalig, Spezyme™, Distillase™, G-Zyme™, Fermenzyme™, Fermgen™, GC 212, or Optimash™) or any other commercial enzyme cocktail can be purchased from vendors such as Specialty Enzymes & Biochemicals Co., Genencor, or Novozymes. Alternatively, enzyme cocktails can be prepared by growing one or more organisms such as for example a fungi (e.g. a Trichoderma, a Saccharomyces, a Pichia, a White Rot Fungus etc.), a bacteria (e.g. a Clostridium, or a coliform bacterium, a Zymomonas bacterium, Sacharophagus degradans etc.) in a suitable medium and harvesting enzymes produced therefrom. In some embodiments, the harvesting can include one or more steps of purification of enzymes.

In one embodiment, treatment of biomass following pretreatment of the biomass using methods and devices provided herein comprises enzyme hydrolysis. In one embodiment a biomass following pretreatment as provided herein is treated with an enzyme or a mixture of enzymes, e.g., endonucleases, exonucleases, cellobiohydrolases, cellulase, beta-glucosidases, glycoside hydrolases, glycosyltransferases, lyases, esterases and proteins containing carbohydrate-binding modules. In one embodiment, the enzyme or mixture of enzymes is one or more individual enzymes with distinct activities. In another embodiment, the enzyme or mixture of enzymes can be enzyme domains with a particular catalytic activity. For example, an enzyme with multiple activities can have multiple enzyme domains, including for example glycoside hydrolases, glycosyltransferases, lyases and/or esterases catalytic domains.

In one embodiment, enzymes that degrade polysaccharides are used for the hydrolysis of biomass and can include enzymes that degrade cellulose, namely, cellulases. Examples of some cellulases include endocellulases and exo-cellulases that hydrolyze beta-1,4-glucosidic bonds.

In one embodiment, enzymes that degrade polysaccharides are used for the hydrolysis of biomass and can include enzymes that have the ability to degrade hemicellulose, namely, hemicellulases. Hemicellulose can be a major component of plant biomass and can contain a mixture of pentoses and hexoses, for example, D-xylopyranose, L-arabinofuranose, D-mannopyranose, Dglucopyranose, D-galactopyranose, D-glucopyranosyluronic acid and other sugars. In one embodiment, enzymes that degrade polysaccharides are used for the hydrolysis of biomass and can include enzymes that have the ability to degrade pectin, namely, pectinases. In plant cell walls, the cross-linked cellulose network can be embedded in a matrix of pectins that can be covalently cross-linked to xyloglucans and certain structural proteins. Pectin can comprise homogalacturonan (HG) or rhamnogalacturonan (RH).

In one embodiment, hydrolysis of biomass includes enzymes that can hydrolyze starch. Enzymes that hydrolyze starch include alpha-amylase, glucoamylase, beta-amylase, exo-alpha-1,4-glucanase, and pullulanase.

In one embodiment, hydrolysis of biomass comprises hydrolases that can include enzymes that hydrolyze chitin, namely, chitinase. In another embodiment, hydrolases can include enzymes that hydrolyze lichen, namely, lichenase.

In one embodiment, more than one of these steps can occur at any given time. For example, hydrolysis of the pretreated feedstock and hydrolysis of the oligosaccharides can occur simultaneously, and one or more of these can occur simultaneously to the conversion of monosaccharides to a fuel or chemical.

In another embodiment, an enzyme can directly convert the polysaccharide to monosaccharides. In some instances, an enzyme can hydrolyze the polysaccharide to oligosaccharides and the enzyme or another enzyme can hydrolyze the oligosaccharides to monosaccharides.

In another embodiment, the enzymes can be added to the fermentation or they can be produced by microorganisms present in the fermentation. In one embodiment, the microorganism present in the fermentation produces some enzymes. In another embodiment, enzymes are produced separately and added to the fermentation.

For the overall conversion of pretreated biomass to final product to occur at high rates, it is generally necessary for each of the necessary enzymes for each conversion step to be present with sufficiently high activity. If one of these enzymes is missing or is present in insufficient quantities, the production rate of an end product can be reduced. The production rate can also be reduced if the microorganisms responsible for the conversion of monosaccharides to product only slowly take up monosaccharides and/or have only limited capability for translocation of the monosaccharides and intermediates produced during the conversion to end product. Additions of fractions obtained from pretreatment and/or pretreatment and hydrolysis can increase initial or overall growth rates. In another embodiment, oligomers are taken up slowly by a biocatalyst, necessitating an almost complete conversion of polysaccharides and oligomers to monomeric sugars.

In another embodiment, the enzymes of the method are produced by a biocatalyst, including a range of hydrolytic enzymes suitable for the biomass materials used in the fermentation methods. In one embodiment, a biocatalyst is grown under conditions appropriate to induce and/or promote production of the enzymes needed for the saccharification of the polysaccharide present. The production of these enzymes can occur in a separate vessel, such as a seed fermentation vessel or other fermentation vessel, or in the production fermentation vessel where ethanol production occurs. When the enzymes are produced in a separate vessel, they can, for example, be transferred to the production fermentation vessel along with the cells, or as a relatively cell free solution liquid containing the intercellular medium with the enzymes. When the enzymes are produced in a separate vessel, they can also be dried and/or purified prior to adding them to the hydrolysis or the production fermentation vessel. The conditions appropriate for production of the enzymes are frequently managed by growing the cells in a medium that includes the biomass that the cells will be expected to hydrolyze in subsequent fermentation steps. Additional medium components, such as salt supplements, growth factors, and cofactors including, but not limited to phytate, amino acids, and peptides can also assist in the production of the enzymes utilized by the microorganism in the production of the desired products.

### Production of Lignin-Based Polyurethane Product

In one embodiment, the lignin produced through extruder pretreatment can be cleaner and more uniform in chemistry and particle size than lignin residues produced with other pretreatment systems. No expensive solvents are needed to dissolve the lignin prior to pretreatment. The small particle size makes it easier to thoroughly hydrolyze with enzymes and thus higher yields of sugars are obtained as well as cleaner lignin residues. Various separation methods, including filtration, rotary press, centrifugation, flocculation, and the like, can be used to separate the sugars from the lignin. Once separated, the lignin can be placed in containers, formed into powders, pellets, bricks or any type of form for further use or transport. This lignin (hereinafter “C-lignin”) can be low cost to produce, has a low ash and sulfur content, and the particle size is small and uniform, unlike other biorefinery lignin and lignin produced from Kraft or sulfur processes. It can be of high purity, having a low carbohydrate content (less than 12%) and is hydrophobic and more reactive than in its natural non-modified form. It can also be homogeneous and porous.

In one embodiment, the C-lignin, except for being dried, does not require any other treatment before mixing with the isocyanate(s). Hence, the dried lignin is used as is and contains both high and low molecular weight lignin fractions. Because it does not need extensive washing or modification, it is much more economical than lignin produced by any other process.

These properties make such lignin a perfect candidate for making better and less expensive biodegradable starch foams, polymers and films. Its naturally water repellant attributes enhance polyurethane lignin films and foams, especially for use in packaging materials, insulating materials, and a myriad of other uses.

Polyurethane foams and plastics are made by reacting a polyol with an isocyanate that has a functionality of at least two or more. Polyols that are suitable for the reaction comprise polyester molecules with a functionality of at least two or a polyether polyol which can react with difunctional or multifunctional isocyanates to produce a solid plastic or foam. Polyols can also include lignin molecules. Most polyisocyanates and polyols used in polyurethane products are derived from fossil oils. Lignins are more environmentally friendly and, using the processes described herein to extract them, are less expensive.

In one embodiment, the C-lignin is liquefied prior to mixing with another polyol before the isocyanate is added. This generally produces a polyether polyol. These C-lignin based polyols can also be synthesized through microwave-assisted liquefaction under 5-30 min or more of different microwave heating times. (Bai-Liang Xue, et al. 2015 Materials 8:586-599)

The isocyanates mixed with the C-lignin to obtain the lignin-isocyanate mixture can be any isocyanate used in known processes for synthetizing polyurethanes. The nature of the isocyanate will depend on the application which is intended for the polyurethane product and a person skilled in the art will understand this process and choose the isocyanate accordingly. The one or more isocyanates are usually applied in liquid form.

In one embodiment the isocyanate is an aliphatic isocyanate or an aromatic isocyanate. Examples of aliphatic isocyanates include, but not limited to, aliphatic diisocyanates such as Hexamethylene diisocyanate (HDI), Isophorone diisocyanate (IPDI), Methylene bis(4-cy-clohexylisocyanate) (H12MDI or Hydrogenated MDI). Aromatic diisocyanates that can be used for mixing with the lignin include, but not limited to, diisocyanates in which the aromatic group is a phenyl or a tolyl. Examples include Methylene diphenyl diisocyanates (MDI), Toluene diisocy-anates (TDI) or Naphtalene diisocyanate (NDI). MDI can be any one or a mixture of the three different isomers 2,2′-MDI, 2,4′-MDI, and 4,4′-MDI or can be polymeric MDI. TDI can be either 2,4-TDI or 2,6-TDI or a mixture of both.

MDI can be used to make rigid, semi-rigid and flexible foams, cast elastomers, thermoplastic elastomers, microcellular elastomers, coatings or binders, and the like. Polymeric MDI can be used to produce rigid polyurethane foams.

TDI can be used in the production of flexible foams (e.g. for mattresses, automobile seats, upholstery cushions, egg cartons, coffins, and other packaging materials). Other types of non-foam polyurethanes based on TDI are useful in coatings, adhesives, paints, binders, and sealants.

NDI can be used in the making of elastomer polyurethanes and aliphatic diisocyanates HDI and IPDI may be used to make polyurethanes useful as paints, coatings, leather finishing, lacquers, foams, or in special applications, such as enamel coatings which are resistant to abrasion and degradation from ultraviolet light (e.g. as coatings for aircraft).

In certain embodiments, the lignin-isocyanate mixture comprises commercial isocyanates including for example Rubinate®, Suprasec® (e.g. Suprasec® 9561), Lupranate®, Desmodur®, Mondur® (e.g. Mondur® 489), Baymidur®, Wannate™ (e.g. Wannate™ PM 700), PAPI™ (e.g. PAPI™ 27), Voranate™ or Isonate™ isocyanates.

In one embodiment, additives may be present in the C-lignin/isocyanate mixture and may not react with the lignin and the isocyanate. Examples of such additives useful for the intended product processing or applications or properties include, but not limited to, viscosity reducers, surfactants, flame retardants, and blowing agents. In some cases, low viscosity flame retardant or blowing agents are also used as the viscosity reducer. Example of flame retardant includes, but not limited to, TCPP (Tri(beta-chloropropyl)phosphate). Example of blowing (foaming) agents include hydrocarbons, halogenated hydrocarbon, hydrofluoroolefins (HFO), hydrochlorofluorocarbon (HCFC), hydrochlorocarbon (HCC), hydrofluorocarbon (HFC), pentafluoropropane or pentafluorobutane/heptafluoropropane.

The quantity of additives in the C-lignin/isocyanate mixture can be adapted depending on the intended application of the polyurethane product.

In one embodiment, the C-lignin/isocyanate mixture may comprise about 100 parts (in weight) of polymeric MDI, about 50 parts of lignin, up to about 12 parts of a flame retardant, up to about 10 parts of a blowing agent and up to about one part of surfactant (for a total of 173 parts). In another embodiment, the C-lignin/isocyanate mixture may comprise about 100 parts (in weight) of MDI, about 50 parts of C-lignin, about 12 parts of a flame retardant, about 6 parts of a blowing agent and about one part of surfactant. Such compositions would produce polyisocyanurate rigid (PIR) foams.

The C-lignin/isocyanate mixture can be obtained by adding the dried lignin to the isocyanate under stirring. The mixing can be done for example using a high shear mixer or using a regular mixer. When additives are used, they can be added to the isocyanate before mixing with the C-lignin or directly to the C-lignin/isocyanate mixture.

Once the C-lignin/isocyanate mixture is obtained, it can either be directly used in the next step of the polyurethane production or stored for being used at a later time. In the latter case, the mixture is kept away from moisture in a hermetic container and preferably kept under stirring for avoiding lignin deposition. In a preferred embodiment, the C-lignin/isocyanate mixture is used in the next step of the process as soon as it has been prepared.

The viscosity of the C-lignin/isocyanate mixture can be varied by additives to the mixture. These can be, for example, low viscosity flame retardants and/or blowing agents. Then the lignin-isocyanate mixture is allowed to react to form urethane bonds between the hydroxyl groups of the lignin and the isocyanate groups to obtain the polyurethane product. This step, which may be called polymerization step, can be performed under different conditions. The polymerization can be carried out by heating the mixture, or in the presence of at least one catalyst, or in the presence of a resin containing at least one polyol and at least one catalyst. A part or all the hydroxyl groups of the lignin are allowed to react. In one embodiment, all the hydroxyl groups of the lignin are allowed to react. When the polymerization involves the use of a polyol containing resin, a polyol-isocyanate-lignin reaction also occurs. In other words, both the hydroxyl groups of the polyol and the hydroxyl groups of the lignin are allowed to react with the isocyanate groups. A polyurethane polymeric network including the lignin is thus allowed to form.

The polymerization step can be performed under different conditions. For example, it can be initiated by heating the isolignin, heating the isolignin in the presence of at least one catalyst, or heating the isolignin in the presence of a resin containing at least one polyol and a catalyst.

When polymerization is initiated by heating the C-lignin-isocyanate mixture, the reaction can be performed at a temperature comprised between about 30° C. and about 150° C., or between about 50° C. and about 140° C. Higher temperatures can produce a less homogeneous mixture.

The polymerization can also be initiated in the presence of at least one catalyst. In this case the catalyst is added to the lignin-isocyanate mixture.

In another embodiment, polymerization is initiated using at least one catalyst and a resin containing at least one polyol. Preferably, the polymerization is initiated using a resin which contains both the polyol(s) and the catalyst.

The resin which reacts with the C-lignin-isocyanate mixture to form the polyurethane product contains at least one polyol. In an embodiment, the resin contains a mixture of polyols. When the resin is mixed with the C-lignin-isocyanate mixture, both the hydroxyl groups of the polyol and the hydroxyl groups of the lignin are allowed to react with the isocyanate groups. The polyurethane which is obtained thus include urethane groups resulting both from reaction with the lignin and with the polyol(s).

The polyol(s) contained in the resin may be any polyol(s) commonly used in the production of polyurethanes, and are divided into two classes: polyester polyols and polyether polyols. For example, they can be aliphatic or aromatic polyester or polyether polyols, halogenated polyether polyols, polyethylene glycols, sucrose-based polyether polyols, amine-based polyether polyols, sucrose/amine based polyether polyols, toluenediamine based polyols, Mannich based polyols, (polytetramethylene glycol) polyols (PTMEG), acrylic polyols, phenolic polyols, lignopolyols, biopolyols extracted from the biomass, such as from soya, castor oil, oil or biosuccinic acid, and from any plant residues. Examples of biopolyols extracted from plant residues include lignin, cellulose and nanocellulose.

The resin can also include, in addition to the polyol(s), certain additives well known by one skilled in the art, for imparting required properties to the final polyurethane product. These additives include, without to be limited to, surfactants, flame retardants, blowing agents, water, antimicrobial agents, pigments, fragrances and/or UV light stabilizers. Other additives such as crosslinkers or chain extenders can also be added to the resin for improving polyurethane properties by forming hard segments into the polymer network. Examples of crosslinkers and chain extenders include low molecular weight polyols or polyamines such as glycerol, diethanola-mine (DEA), triethanolamine (TEA), trimethylol propane, ethylene glycol, propylene glycol, dimethylthiotoluenediamine (DMTDA), 1,4-butanediol, or diethyltoluene-diamine (DETDA). The additives are usually present in less than about 20 wt % of formulated polyols, but can be present in more than about 50% in some applications.

A catalyst(s) which may be used alone, in combination with the polyol, or which is present in the polyol containing resin can be chosen in the two main classes of catalyst used in polyurethane production which include metal catalysts and amine catalysts, alone or in combination. The quantity of catalysts is usually very small in comparison with the other additives. For example, catalysts are used at less than about 5% by weight of the resin formulation.

Metal catalysts are commonly used to accelerate the reaction and formation of urethane linkages and hence promote rapid curing. Some of them also promote the isocyanurate reaction. They are based, without being limited to, on mercury, lead, tin, bismuth, potassium and zinc. Examples of metal catalysts include dibutyltin dilaurate, stannous octoate and potassium octoate.

Amine catalysts are generally used to promote crosslinking and are often tertiary amines. Amine catalysts can be, without being limited to, alkyl amines such as triethylenediamine (TEDA) also called 1,4-diazabicyclo[2.2.2]octane (DABCO), benzyldimethylamine (BDMA), pentameth-yldiethylenetriamine (PMDETA), or dimethylcyclohexylamine (DMCHA), or ethanol amines such as dimethylethanolamine (DMEA) or triethanolamine (TEA).

The ratio of resin to lignin-isocyanate mixture used in the process depends on the application intended for the final polyurethane product. A person skilled in the art would be able to calculate the quantities of C-lignin-isocyanate mixture and resin to be used for the required application. For example, the C-lignin-isocyanate mixture can be reacted with the resin in a weight ratio of resin to lignin-isocyanate mixture of from about 0.3:1 to about 0.8:1 to form polyisocyanurate rigid (PIR) foams. In another example, the weight ratio of resin to C-lignin-isocyanate mixture would be from about 2:1 to about 4:1 to form semi-flexible polyurethane foams. In order to make spray polyurethane foam (SPF), one may use a weight ratio of resin to C-lignin-isocyanate mixture of from about 0.85 to 1.15.

When the polymerization takes place in the presence of wood particles or wood fibers as additives, one may obtain polyurethane particle board or fiberboards. In this case, the polyurethane can be said to be used as a sealant or adhesive.

Various types of polyurethanes can be produced by varying the physical parameters under which the polyurethane is produced or by including additives to the mixture. For example, when the polymerization takes place with a catalyst or with heat only, when the product is made from the isocyanate and lignin only without using a polyol resin, rigid boards can be obtained that have many different applications (construction, furniture, molding, etc).

The reaction of the C-lignin-isocyanate mixture with the polyol-containing resin can be performed in different ways depending on the intended application for the final polyurethane product. The reaction can be done at or near to room temperature. However, it could also be possible to do the reaction at a temperature comprised between about 20° C. to about 30° C., about 30° C. to about 40° C., about 40° C. to about 50° C., about 50° C., about 60° C., about 60° C., about 70° C., about 80° C., about 90° C., about 100° C., about 110° C., about 120° C., about 130° C., about 140° C., or about 150° C., 160° C., 170° C., or higher.

Varying the amount of the lignin(s), the isocyanate (s), the polyol(s) and/or the additives, the process can be used to prepare a large variety of different polyurethane products. These polyurethane products can include, without being limited, to rigid foams, flexible foams, rigid boards, rigid blocks, coatings, packaging, adhesives, binders, sealants (one- or two-component sealants), elastomers, Thermoplastic Polyurethanes (TPUs) or Reaction Injection Molding (RIM).

In another application, for insulation, the polyurethane foam can be produced on-site by spraying a blend of the lignin-isocyanate mixture with the polyol containing resin onto the surface to be insulated. More particularly, the lignin-isocyanate mixture and the resin, which are provided in separate containers, are each sent from the container to a spray gun through a tube where they are allowed to be mixed when the manipulator operate the gun. The polymerization reaction is allowed to start as soon as the reaction mixture exits the nozzle of the spray gun and the closed cell or open cell foam forms on the surface.

Other types of lignin-based polyurethane panels where the polyurethane is formed between two rigid protection boards, such as plywood boards, can be produced using the present process. In this case, a first plywood board is positioned in a mold and a second plywood board is positioned in the mold at a predetermined distance above the first sheet. Then, the C-lignin-isocyanate mixture and the polyol-containing resin are blended and the resulting mixture is immediately injected in the mold in the space between the two plywood boards. The polymerization reaction is allowed to start as soon as the reaction mixture is injected into the mold and the polyurethane foam forms between the two plywood boards. The resulting panels are structural insulating panels which can be used for building walls or roofs in the construction industry.

The present process allows the production of improved lignin-based polyurethane products containing relatively large amounts of lignin with improved homogeneity and composition, and/or better foaming qualities. Since lignin has natural UV protection properties, these plastics and foams are less likely to break down or crack under UV exposure conditions. They can also be manufactured more rapidly at lower cost. Since lignin is less expensive than conventional polyols, the cost can be further reduced while having a smaller environmental footprint.

In some embodiments, the process preferably does not require the use of any organic solvent as would in other known processes. This is also beneficial for environmental and economic aspects.

In addition, the process does not require installing expensive new equipment. The same equipment as those known to produce polyurethane products, or with minor modifications, can be used. The process can thus be readily implemented.

In a further embodiment, C-lignin can be used for making films with such other natural products as cellulose. Films made with C-lignin can be used in many applications where UV protection is warranted. This includes packaging and protective films such as for edible materials, paints, glasses, such as sunglasses, cosmetics, and the like.

Approximately one-third of worldwide plastics production is the production of films. Films can be single or multilayered or biaxially oriented, used to package goods as shrink films, wrap films and the like. They provide barrier and sealing properties. There is great demand to replace the non-biodegradable polyolefins and PET or at least part of them, with materials that degrade over time. Their uses are numerous and worldwide, including, but not limited to bags, sachets, nets, containers, bottles, mulch films, meshes, electronic screens, vehicle components, and the like.

One such method to make a cellulose-lignin film is to covalently bind lignin to cellulose by modifying the cellulose so that it will react with the lignin.

In another aspect, the products made by any of the processes described herein are provided.

### SPECIFIC EMBODIMENTS

A number of methods and systems are disclosed herein. Specific exemplary embodiments of these methods and systems are disclosed below.

### Embodiment 1

A polyurethane product comprising a polymerization product of an isocyanate and polyols that comprise a lignin product; wherein the polyurethane product has a higher compressive strength than polyurethane made under same conditions except without the lignin product; and wherein the lignin product is a solid residue from a pretreatment and hydrolysis of a biomass, whereby at least 80% of carbohydrates in the biomass are extracted and separated from the solid residue.

### Embodiment 2

A polyurethane product comprising a polymerization product of an isocyanate and polyols that comprise a lignin product, the lignin product being made by:

(a) pretreating a biomass within a pretreatment unit at an elevated temperature and pressure to produce a pretreated biomass;

(b) hydrolyzing the pretreated biomass to produce soluble carbohydrates and lignin residue; and

(c) water washing and drying the lignin residue to produce the lignin product.

### Embodiment 3

The polyurethane product of embodiment 1 or 2, wherein the lignin product has a carbohydrate content of at most 20%, 15%, 12%, 10%, 8%, 6%, 5%, 4%, 3%, 2%, 1% by weight.

### Embodiment 4

The polyurethane product of any one of embodiments 1-3, wherein the lignin product has a carbohydrate content of at most 5% by weight.

### Embodiment 5

The polyurethane product of any one of embodiments 1-4, wherein the lignin product has a sulfur content of at most 5%, 3%, 2%, 1.5%, 1%, 0.8%, 0.6%, 0.5%, 0.4%, 0.3%, 0.2%, 0.1%, 0.05%, 0.02%, or 0.01% by weight.

### Embodiment 6

The polyurethane product of any one of embodiments 1-5, wherein the lignin product has a sulfur content of at most 0.2% by weight.

### Embodiment 7

The polyurethane product of any one of embodiments 1-6, wherein the lignin product has an ash content of at most 5% by weight.

### Embodiment 8

The polyurethane product of any one of embodiments 1-7, wherein the lignin product has an ash content of at most 2% by weight.

### Embodiment 9

The polyurethane product of any one of embodiments 1-8, wherein the weight ratio of the lignin product to the isocyanate is at least 1:100, 1:80, 1:60, 1:50, 1:20, 1:15, 1:12.5, 1:10, 1:9, 1:8, 1:7, 1:6, 1:5, 1:4, 1:3, 1:2, 1:1.8, 1:1.6, 1:1.5, 1:1.4, 1:1.3, 1:1.2, 1:1.1, 1:1, 1:0.8, 1:0.6, 1:0.5, or 1:0.1, or in between any two of these values.

### Embodiment 10

The polyurethane product of any one of embodiments 1-9, wherein at least 0.1%, 0.5%, 1%, 2.5%, 5%, 6%, 8%, 10%, 12%, 14%, 16%, 18%, 19%, 20%, 21%, 22%, 23%, 24%, 25%, 26%, 28%, 30%, 50%, or a percentage between any two of these values, of the polyurethane product by weight is the lignin product.

### Embodiment 11

The polyurethane product of any one of embodiments 1-10, wherein about 1% to about 30% of the polyurethane product by weight is the lignin product.

### Embodiment 12

The polyurethane product of any one of embodiments 1-11, wherein at least 0.5%, 1%, 2%, 5%, 10%, 25%, 50%, 75%, 80%, 90%, 95%, 98%, or 99%, or about 100% of the polyols by weight are the lignin product.

### Embodiment 13

The polyurethane product of any one of embodiments 1-12, wherein the lignin product is at least 0.5% of the polyols by weight.

### Embodiment 14

The polyurethane product of any one of embodiments 1-13, wherein the lignin product is at least 1% of the polyols by weight.

### Embodiment 15

The polyurethane product of any one of embodiments 1-14, wherein the lignin product is at least 5% of the polyols by weight.

### Embodiment 16

The polyurethane product of any one of embodiments 1-15, wherein the lignin product is at least 15% of the polyols by weight.

### Embodiment 17

The polyurethane product of any one of embodiments 1 or 3-16, wherein the pretreatment comprises:

(i) pretreating the biomass within a pretreatment unit at an elevated temperature and pressure to produce a pretreated biomass;

(ii) hydrolyzing the pretreated biomass to produce soluble carbohydrates and lignin residue; and

(iii) water washing and drying the lignin residue to produce the lignin product.

### Embodiment 18

The polyurethane product of any one of embodiments 2-17, wherein the pretreating comprises mechanical processing of the biomass for particle size reduction.

### Embodiment 19

The polyurethane product of embodiment 18, wherein the reduced particle size is in a range of about: 1-500 μm, 1-250 μm, 1-200 μm, or 1-150 μm.

### Embodiment 20

The polyurethane product of embodiment 18, wherein the reduced particle size is about 15-25 μm on average.

### Embodiment 21

The polyurethane product of any one of embodiments 2-20, wherein the pretreating comprises providing a non-pH neutral medium to the biomass in the pretreatment unit.

### Embodiment 22

The polyurethane product of embodiment 21, wherein the non-pH neutral medium has a pH that is about: 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or 0.1, or in between any two of these values.

### Embodiment 23

The polyurethane product of embodiment 21 or 22, wherein the non-pH neutral medium has a pH that is about: 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, or 13.9, or in between any two of these values.

### Embodiment 24

The polyurethane product of any one of embodiments 21-23, wherein the non-pH neutral medium comprises an acid that is sulfuric acid, peroxyacetic acid, lactic acid, formic acid, acetic acid, citric acid, phosphoric acid, hydrochloric acid, sulfurous acid, chloroacetic acid, dichloroacetic acid, trichloroacetic acid, trifluoroacetic acid, oxalic acid, benzoic acid, or any combination thereof.

### Embodiment 25

The polyurethane product of any one of embodiments 21-24, wherein the non-pH neutral medium comprises sulfuric acid.

### Embodiment 26

The polyurethane product of embodiment 25, wherein the sulfuric acid has a concentration of 5% or less by biomass weight.

### Embodiment 27

The polyurethane product of any one of embodiments 2-26, wherein the pretreating comprises steam explosion.

### Embodiment 28

The polyurethane product of any one of embodiments 2-27, wherein the elevated temperature is provided by steam, a heat jacket, or a combination thereof.

### Embodiment 29

The polyurethane product of any one of embodiments 2-28, wherein the elevated temperature is about: 50-500° C., 75-400° C., 100-350° C., 150-300° C., or 200-250° C.

### Embodiment 30

The polyurethane product of any one of embodiments 2-29, wherein the elevated pressure is maintained by addition of steam, liquid, biomass, or a combination thereof.

### Embodiment 31

The polyurethane product of any one of embodiments 2-30, wherein the elevated pressure is about: 50-1000 PSI, 100-750 PSI, 200-600 PSI, 300-500 PSI or 350-450 PSI.

### Embodiment 32

The polyurethane product of any one of embodiments 2-31, wherein the hydrolyzing is performed with enzymes, acids, bases, or any combination thereof.

### Embodiment 33

The method of embodiment 32, wherein the hydrolyzing is performed with the enzymes, which comprise cellulase, hemicellulose, amylase, β-glucosidase, xylanase, gluconase, other polysaccharases, lysozyme, laccase, and other lignin-modifying enzymes, lipoxygenase, peroxidase, other oxidative enzymes, proteases, lipases, or any combination thereof.

### Embodiment 34

The method of embodiment 32, wherein the hydrolyzing is performed with the enzymes, which comprise cellulase, hemicellulose, or a combination thereof.

### Embodiment 35

The polyurethane product of any one of embodiments 2-34, wherein the pretreatment unit comprises:

(a) a barrel defining an inner chamber and comprising an inlet port near of first end of the barrel and an end flange plate at a second end of the barrel;

(b) one or more rotatable screws configured to move the biomass through the inner chamber of the barrel and containing one or more sections configured to form one or more plugs from the biomass to separate the inner chamber of the barrel into two or more zones, including a feeder zone and a reaction zone; and

(c) a pressure actuated discharge valve connected to the end flange plate and configured to open and close in response to pressure within the barrel, thereby allowing for continuous production of a pretreated biomass composition comprising a liquid fraction comprising monosaccharides and solid particles comprising cellulose.

### Embodiment 36

The polyurethane product of any one of embodiments 2-35, wherein the pretreatment unit comprises one, two, or three rotatable screws.

### Embodiment 37

The polyurethane product of any one of embodiments 2-36, wherein the pretreatment unit comprises two rotatable screws.

### Embodiment 38

The polyurethane product of any one of embodiments 2-37, wherein the pretreatment unit further comprises a motor configured to rotate the one or more rotatable screws.

### Embodiment 39

The polyurethane product of any one of embodiments 38, wherein the motor is configured to rotate the one or more rotatable screws at about: 100, 250, 400, 500, 750, 1000, 1100, 1250, 1500, or 2000 RPMs.

### Embodiment 40

The polyurethane product of any one of embodiments 2-39, wherein the pretreatment unit is capable of processing biomass at a rate at least about: 2 dry MT/day, 3 dry MT/day, 4 dry MT/day, 5 dry MT/day, 7.5 dry MT/day, 10 dry MT/day, 15 dry MT/day, 20 dry MT/day, 25 dry MT/day, 50 dry MT/day, 75 dry MT/day, 100 dry MT/day, 150 dry MT/day, or 200 dry MT/day.

### Embodiment 41

The polyurethane product of any one of embodiments 2-40, wherein the pretreatment unit further comprises a hopper connected to the inlet port for feeding the biomass into the feeder zone.

### Embodiment 42

The polyurethane product of embodiment 41, wherein the hopper further comprises a feeder configured to move the biomass from the hopper through the inlet port.

### Embodiment 43

The polyurethane product of embodiment 42, wherein the feeder is a delivery auger configured to distribute the biomass evenly into the feeder zone.

### Embodiment 44

The polyurethane product of any one of embodiments 41-43, wherein the hopper comprises one or more sealable ports configured to add a liquid to biomass in the hopper.

### Embodiment 45

The polyurethane product of any one of embodiments 35-44, wherein the barrel further comprises one or more sealable ports configured to add liquid to the biomass in the feeder zone.

### Embodiment 46

The polyurethane product of any one of embodiments 35-45, wherein the rotatable screws are capable of conveying the biomass through the reaction zone in less than about: 20, 19, 18, 17, 16, 15, 14, 13, 12, 10, 9, 8, 7, 6, 5, 4, 3, 2, or 1 seconds.

### Embodiment 47

The polyurethane product of any one of embodiments 35-46, wherein the rotatable screws are capable of conveying the biomass through the reaction zone in about 5 to 15 seconds.

### Embodiment 48

The polyurethane product of any one of embodiments 35-47, wherein the barrel further comprises one or more sealable ports configured to add steam to the reaction zone.

### Embodiment 49

The polyurethane product of any one of embodiments 35-48, wherein the barrel further comprises a heat jacket.

### Embodiment 50

The polyurethane product of any one of embodiments 35-49, wherein the barrel further comprises one or more sealable ports configured to add one or more chemical agents to the reaction zone.

### Embodiment 51

The polyurethane product of embodiment 50, wherein the chemical agent comprises an acid, a base, or a combination thereof.

### Embodiment 52

The polyurethane product of any one of embodiments 35-51, wherein the pressure actuated discharge valve comprises a poppet valve, a ball valve, a check valve, or a rotating knife-gate valve.

### Embodiment 53

The polyurethane product of any one of embodiments 35-52, wherein the pressure actuated discharge valve comprises a poppet valve.

### Embodiment 54

The polyurethane product of any one of embodiments 35-53, wherein the pressure actuated discharge valve is connected to an actuator.

### Embodiment 55

The polyurethane product of embodiment 54, wherein the actuator is a pneumatic actuator, a hydraulic actuator, an electro-mechanical actuator, or a combination thereof.

### Embodiment 56

The polyurethane product of embodiment 54 or 55, wherein the actuator is operably coupled to a back pressure control unit.

### Embodiment 57

The polyurethane product of embodiment 56, wherein the back pressure control unit is operably coupled to one or more pressure gauges.

### Embodiment 58

The polyurethane product of embodiment 57, wherein the one or more pressure gauges monitor pressure in the barrel via one or more sealable ports in the barrel.

### Embodiment 59

The polyurethane product of embodiment 58, at least one of the one or more pressure gauges is configured to monitor pressure within the reaction zone.

### Embodiment 60

The polyurethane product of any one of embodiments 35-59, wherein the barrel further comprises one or more ports comprising a temperature gauge, a pressure gauge, or a combination thereof.

### Embodiment 61

The polyurethane product of any one of embodiments 2-60, wherein the pretreatment unit further comprises a flash tank.

### Embodiment 62

The polyurethane product of embodiment 61, wherein the flash tank collects the pretreated biomass composition as it exits the pressure actuated discharge valve.

### Embodiment 63

The polyurethane product of any one of embodiments 1-62, wherein the lignin product has a particle size in a range of about: 1-500 μm, 1-250 μm, 1-200 μm, or 1-150 μm.

### Embodiment 64

The polyurethane product of any one of embodiments 1-63, wherein the lignin product has a particle size that is about 15-25 μm on average.

### Embodiment 65

The polyurethane product of any one of embodiments 1-64, wherein the biomass comprises algae, corn, grass, straw, wood, bark, sawdust, paper, poplars, willows, switchgrass, alfalfa, prairie bluestem, sugar palms, nypa palm, cassava, milo, sorghum, sweet potatoes, molasses, tubers, roots, stems, sago, cassaya, tapioca, rice peas, beans, potatoes, beets, fruits, pits, sorghum, sugar cane, rice, wheat, whole grains, rye, barley, bamboo, seeds, oats, or a combination thereof, or a derivative or byproduct thereof.

### Embodiment 66

The polyurethane product of embodiment 65, wherein the derivative or byproduct thereof comprises corn stover, corn cobs, corn mash, corn fiber, silage, bagasse, distiller's grains, distiller's dried solubles, distiller's dried grains, condensed distiller's solubles, distiller's wet grains, distiller's dried grains with solubles, fiber, fruit peels, rice straw, grain hulls, rice hulls, wheat straw, barley straw, seed hulls, oat hulls, food waste, municipal sewage waste, or a combination thereof.

### Embodiment 67

The polyurethane product of any one of embodiments 1-66, wherein the biomass comprises a woody biomass.

### Embodiment 68

The polyurethane product of any one of embodiments 1-67, wherein the polyurethane product is a polyurethane foam.

### Embodiment 69

The polyurethane product of any one of embodiments 1-68, wherein the polyurethane product is a polyurethane plastic.

### Embodiment 70

A polyurethane foam comprising a polymerization product of an isocyanate and a lignin-containing solution, the lignin-containing solution formed by dissolving a powdered lignin directly in a solution comprising polyols other than lignin.

### Embodiment 71

The polyurethane foam of embodiment 70, wherein the powdered lignin has a carbohydrate content of at most 20%, 15%, 12%, 10%, 8%, 6%, 5%, 4%, 3%, 2%, 1% by weight.

### Embodiment 72

The polyurethane foam of embodiment 70 or 71, wherein the powdered lignin has a carbohydrate content of at most 5% by weight.

### Embodiment 73

The polyurethane foam of any one of embodiments 70-72, wherein the powdered lignin has a sulfur content of at most 5%, 3%, 2%, 1.5%, 1%, 0.8%, 0.6%, 0.5%, 0.4%, 0.3%, 0.2%, 0.1%, 0.05%, 0.02%, or 0.01% by weight.

### Embodiment 74

The polyurethane foam of any one of embodiments 70-73, wherein the powdered lignin has a sulfur content of at most 0.2% by weight.

### Embodiment 75

The polyurethane foam of any one of embodiments 70-74, wherein the powdered lignin has an ash content of at most 5% by weight.

### Embodiment 76

The polyurethane foam of any one of embodiments 70-75, wherein the powdered lignin has an ash content of at most 2% by weight.

### Embodiment 77

The polyurethane foam of any one of embodiments 70-76, wherein the powdered lignin has a particle size that is in a range of about: 1-500 μm, 1-250 μm, 1-200 μm, or 1-150 μm.

### Embodiment 78

The polyurethane foam of any one of embodiments 70-77, wherein the powdered lignin has a particle size that is about 15-25 μm on average.

### Embodiment 79

The polyurethane foam of any one of embodiments 70-78, wherein the dissolution is carried out with stirring the solution.

### Embodiment 80

The polyurethane foam of any one of embodiments 70-79, wherein the solution for the dissolution of the powdered lignin has a pH that is about: 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or 0.1, or in between any two of these values.

### Embodiment 81

The polyurethane foam of any one of embodiments 70-80, wherein the solution for the dissolution of the powdered lignin has a pH that is about: 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, or 13.9, or in between any two of these values.

### Embodiment 82

The polyurethane foam of any one of embodiments 70-81, wherein the dissolution is carried out at a temperature that is about 20° C. to about 30° C., about 30° C. to about 40° C., about 40° C. to about 50° C., about 50° C., about 60° C., about 60° C., about 70° C., about 80° C., about 90° C., about 100° C., about 110° C., about 120° C., about 130° C., about 140° C., or about 150° C., 160° C., 170° C., or higher.

### Embodiment 83

The polyurethane foam of any one of embodiments 70-82, wherein the dissolution is carried out at a temperature that is about 140° C.

### Embodiment 84

The polyurethane foam of any one of embodiments 70-83, wherein the polyurethane foam has a compressive strength higher than polyurethane foam made under same conditions except without the lignin product.

### Embodiment 85

A method of preparing a polyurethane product comprising: contacting an isocyanate with polyols that comprise a lignin product under conditions sufficient for a polymerization reaction to produce the polyurethane product; wherein the polyurethane product has a higher compressive strength than polyurethane made under same conditions except without the lignin product; and wherein the lignin product is a solid residue from a pretreatment and hydrolysis of a biomass, whereby at least 80% of carbohydrates in the biomass are extracted and separated from the solid residue.

### Embodiment 86

A method of preparing a polyurethane product comprising:

(a) pretreating a biomass within a pretreatment unit at an elevated temperature and pressure to produce a pretreated biomass;

(b) hydrolyzing the pretreated biomass to produce soluble carbohydrates and lignin residue;

(c) water washing and drying the lignin residue to produce a lignin product; and

(d) contacting an isocyanate with polyols that comprise the lignin product under conditions sufficient for a polymerization reaction to produce the polyurethane product.

### Embodiment 87

The method of embodiment 85 or 86, wherein the weight ratio of the lignin product to the isocyanate is at least 1:100, 1:80, 1:60, 1:50, 1:20, 1:15, 1:12.5, 1:10, 1:9, 1:8, 1:7, 1:6, 1:5, 1:4, 1:3, 1:2, 1:1.8, 1:1.6, 1:1.5, 1:1.4, 1:1.3, 1:1.2, 1:1.1, 1:1, 1:0.8, 1:0.6, 1:0.5, or 1:0.1, or in between any two of these values.

### Embodiment 88

The method of any one of embodiments 85-87, wherein the at least 0.1%, 0.5%, 1%, 2.5%, 5%, 6%, 8%, 10%, 12%, 14%, 16%, 18%, 19%, 20%, 21%, 22%, 23%, 24%, 25%, 26%, 28%, 30%, 50%, or a percentage between any two of these values, of the polyurethane product by weight is the lignin product.

### Embodiment 89

The method of any one of embodiments 85-88, wherein about 1% to about 30% of the polyurethane product by weight is the lignin product.

### Embodiment 90

The method of any one of embodiments 85-89, wherein the lignin product is at least 0.5%, 1%, 2%, 5%, 10%, 25%, 50%, 75%, 80%, 90%, 95%, 98%, or 99%, or about 100% of the polyols by weight.

### Embodiment 91

The method of any one of embodiments 85-90, wherein the lignin product is at least 0.5% of the polyols by weight.

### Embodiment 92

The method of any one of embodiments 85-91, wherein the lignin product is at least 1% of the polyols by weight.

### Embodiment 93

The method of any one of embodiments 85-92, wherein the lignin product is at least 5% of the polyols by weight.

### Embodiment 94

The method of any one of embodiments 85-93, wherein the lignin product is at least 15% of the polyols by weight.

### Embodiment 95

The method of any one of embodiments 85 or 87-94, wherein the pretreatment comprises:

(i) pretreating the biomass within a pretreatment unit at an elevated temperature and pressure to produce a pretreated biomass;

(ii) hydrolyzing the pretreated biomass to produce soluble carbohydrates and lignin residue; and

(iii) water washing and drying the lignin residue to produce the lignin product.

### Embodiment 96

The method of any one of embodiments 85-95, wherein the pretreating comprises mechanical processing of the biomass for particle size reduction.

### Embodiment 97

The method of embodiment 96, wherein the reduced particle size is in a range of about: 1-500 μm, 1-250 μm, 1-200 μm, or 1-150 μm.

### Embodiment 98

The method of embodiment 96, wherein the reduced particle size is about 15-25 μm on average.

### Embodiment 99

The method of any one of embodiments 85-98, wherein the pretreating comprises providing a non-pH neutral medium to the biomass in the pretreatment unit.

### Embodiment 100

The method of embodiment 99, wherein the non-pH neutral medium has a pH that is about: 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or 0.1, or in between any two of these values.

### Embodiment 101

The method of embodiment 99 or 100, wherein the non-pH neutral medium has a pH that is about: 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, or 13.9, or in between any two of these values.

### Embodiment 102

The method of any one of embodiments 99-101, wherein the non-pH neutral medium comprises an acid that is sulfuric acid, peroxyacetic acid, lactic acid, formic acid, acetic acid, citric acid, phosphoric acid, hydrochloric acid, sulfurous acid, chloroacetic acid, dichloroacetic acid, trichloroacetic acid, trifluoroacetic acid, oxalic acid, benzoic acid, or any combination thereof.

### Embodiment 103

The method of any one of embodiments 99-101, wherein the non-pH neutral medium comprises sulfuric acid.

### Embodiment 104

The method of embodiment 103, wherein the sulfuric acid has a concentration of 5% or less by biomass weight.

### Embodiment 105

The method of any one of embodiments 85-104, wherein the pretreating comprises steam explosion.

### Embodiment 106

The method of any one of embodiments 85-105, wherein the elevated temperature is provided by steam, a heat jacket, or a combination thereof.

### Embodiment 107

The method of any one of embodiments 85-106, wherein the elevated temperature is about: 50-500° C., 75-400° C., 100-350° C., 150-300° C., or 200-250° C.

### Embodiment 108

The method of any one of embodiments 85-107, wherein the elevated pressure is maintained by addition of steam, liquid, biomass, or a combination thereof.

### Embodiment 109

The method of any one of embodiments 85-108, wherein the elevated pressure is about: 50-1000 PSI, 100-750 PSI, 200-600 PSI, 300-500 PSI or 350-450 PSI.

### Embodiment 110

The method of any one of embodiments 85-109, wherein the hydrolyzing is performed with enzymes, acids, bases, or any combination thereof.

### Embodiment 111

The method of embodiment 110, wherein the hydrolyzing is performed with the enzymes, which comprise cellulase, hemicellulose, amylase, β-glucosidase, xylanase, gluconase, other polysaccharases, lysozyme, laccase, and other lignin-modifying enzymes, lipoxygenase, peroxidase, other oxidative enzymes, proteases, lipases, or any combination thereof.

### Embodiment 112

The method of embodiment 110, wherein the hydrolyzing is performed with the enzymes, which comprise cellulase, hemicellulose, or a combination thereof.

### Embodiment 113

The method of any one of embodiments 85-112, wherein the pretreatment unit comprises:

(a) a barrel defining an inner chamber and comprising an inlet port near of first end of the barrel and an end flange plate at a second end of the barrel;

(b) one or more rotatable screws configured to move the biomass through the inner chamber of the barrel and containing one or more sections configured to form one or more plugs from the biomass to separate the inner chamber of the barrel into two or more zones, including a feeder zone and a reaction zone; and

(c) a pressure actuated discharge valve connected to the end flange plate and configured to open and close in response to pressure within the barrel, thereby allowing for continuous production of a pretreated biomass composition comprising a liquid fraction comprising monosaccharides and solid particles comprising cellulose.

### Embodiment 114

The method of any one of embodiments 85-113, wherein the pretreatment unit comprises one, two, or three rotatable screws.

### Embodiment 115

The method of any one of embodiments 85-114, wherein the pretreatment unit comprises two rotatable screws.

### Embodiment 116

The method of any one of embodiments 85-115, wherein the pretreatment unit further comprises a motor configured to rotate the one or more rotatable screws.

### Embodiment 117

The method of embodiment 116, wherein the motor is configured to rotate the one or more rotatable screws at about: 100, 250, 400, 500, 750, 1000, 1100, 1250, 1500, or 2000 RPMs.

### Embodiment 118

The method of any one of embodiments 85-117, wherein the pretreatment unit is capable of processing biomass at a rate at least about: 2 dry MT/day, 3 dry MT/day, 4 dry MT/day, 5 dry MT/day, 7.5 dry MT/day, 10 dry MT/day, 15 dry MT/day, 20 dry MT/day, 25 dry MT/day, 50 dry MT/day, 75 dry MT/day, 100 dry MT/day, 150 dry MT/day, or 200 dry MT/day.

### Embodiment 119

The method of any one of embodiments 85-118, wherein the pretreatment unit further comprises a hopper connected to the inlet port for feeding the biomass into the feeder zone.

### Embodiment 120

The method of embodiment 119, wherein the hopper further comprises a feeder configured to move the biomass from the hopper through the inlet port.

### Embodiment 121

The method of embodiment 120, wherein the feeder is a delivery auger configured to distribute the biomass evenly into the feeder zone.

### Embodiment 122

The method of any one of embodiments 119-121, wherein the hopper comprises one or more sealable ports configured to add a liquid to biomass in the hopper.

### Embodiment 123

The method of any one of embodiments 113-122, wherein the barrel further comprises one or more sealable ports configured to add liquid to the biomass in the feeder zone.

### Embodiment 124

The method of any one of embodiments 113-123, wherein the rotatable screws are capable of conveying the biomass through the reaction zone in less than about: 20, 19, 18, 17, 16, 15, 14, 13, 12, 10, 9, 8, 7, 6, 5, 4, 3, 2, or 1 seconds.

### Embodiment 125

The method of any one of embodiments 113-124, wherein the rotatable screws are capable of conveying the biomass through the reaction zone in about 5 to 15 seconds.

### Embodiment 126

The method of any one of embodiments 113-125, wherein the barrel further comprises one or more sealable ports configured to add steam to the reaction zone.

### Embodiment 127

The method of any one of embodiments 113-126, wherein the barrel further comprises a heat jacket.

### Embodiment 128

The method of any one of embodiments 113-127, wherein the barrel further comprises one or more sealable ports configured to add one or more chemical agents to the reaction zone.

### Embodiment 129

The method of embodiment 128, wherein the chemical agent comprises an acid, a base, or a combination thereof.

### Embodiment 130

The method of any one of embodiments 113-129, wherein the pressure actuated discharge valve comprises a poppet valve, a ball valve, a check valve, or a rotating knife-gate valve.

### Embodiment 131

The method of any one of embodiments 113-130, wherein the pressure actuated discharge valve comprises a poppet valve.

### Embodiment 132

The method of any one of embodiments 113-131, wherein the pressure actuated discharge valve is connected to an actuator.

### Embodiment 133

The method of embodiment 132, wherein the actuator is a pneumatic actuator, a hydraulic actuator, an electro-mechanical actuator, or a combination thereof.

### Embodiment 134

The method of embodiment 132 or 133, wherein the actuator is operably coupled to a back pressure control unit.

### Embodiment 135

The method of embodiment 134, wherein the back pressure control unit is operably coupled to one or more pressure gauges.

### Embodiment 136

The method of embodiment 135, wherein the one or more pressure gauges monitor pressure in the barrel via one or more sealable ports in the barrel.

### Embodiment 137

The method of embodiment 136, at least one of the one or more pressure gauges is configured to monitor pressure within the reaction zone.

### Embodiment 138

The method of any one of embodiments 113-137, wherein the barrel further comprises one or more ports comprising a temperature gauge, a pressure gauge, or a combination thereof.

### Embodiment 139

The method of any one of embodiments 113-138, wherein the pretreatment unit further comprises a flash tank.

### Embodiment 140

The method of embodiment 139, wherein the flash tank collects the pretreated biomass composition as it exits the pressure actuated discharge valve.

### Embodiment 141

The method of any one of embodiments 85-140, wherein the lignin residue has a particle size in a range of about: 1-500 μm, 1-250 μm, 1-200 μm, or 1-150 μm.

### Embodiment 142

The method of any one of embodiments 85-141, wherein the lignin residue has a particle size that is about 15-25 μm on average.

### Embodiment 143

The method of any one of embodiments 85-142, wherein the lignin product after water washing and drying has a moisture content that is at most about 20%, 10%, 5%, 1%, or 0.5% by weight of the total mass.

### Embodiment 144

The method of any one of embodiments 85-143, wherein the lignin product for the contacting is in a form of powder, brick, pellet, brick, any other form, or any combination thereof.

### Embodiment 145

The method of any one of embodiments 85-144, wherein the lignin product has a carbohydrate content of at most 20%, 15%, 12%, 10%, 8%, 6%, 5%, 4%, 3%, 2%, 1% by weight.

### Embodiment 146

The method of any one of embodiments 85-145, wherein the lignin product has a carbohydrate content of at most 5% by weight.

### Embodiment 147

The method of any one of embodiments 85-146, wherein the lignin product has a sulfur content of at most 5%, 3%, 2%, 1.5%, 1%, 0.8%, 0.6%, 0.5%, 0.4%, 0.3%, 0.2%, 0.1%, 0.05%, 0.02%, or 0.01% by weight.

### Embodiment 148

The method of any one of embodiments 85-147, wherein the lignin product has a sulfur content of at most 0.2% by weight.

### Embodiment 149

The method of any one of embodiments 85-148, wherein the lignin product has an ash content of at most 5% by weight.

### Embodiment 150

The method of any one of embodiments 85-149, wherein the lignin product has an ash content of at most 2% by weight.

### Embodiment 151

The method of any one of embodiments 85-150, the polyols further comprises polyether polyol, polyester polyol, or a combination thereof.

### Embodiment 152

The method of any one of embodiments 85-151, wherein the polyols further comprises aliphatic or aromatic polyester or polyether polyols, halogenated polyether polyols, polyethylene glycols, sucrose-based polyether polyols, amine-based polyether polyols, sucrose/amine based polyether polyols, toluenediamine based polyols, Mannich based polyols, (polytetramethylene glycol) polyols (PTMEG), acrylic polyols, phenolic polyols, lignopolyols, biopolyols extracted from a biomass, or any combination thereof.

### Embodiment 153

The method of any one of embodiments 85-152, wherein the polyols further comprises polyols contained in a polyurethane resin.

### Embodiment 154

The method of embodiment 153, wherein the polyurethane resin comprises additives that are surfactants, flame retardants, blowing agents, water, antimicrobial agents, pigments, fragrances, UV light stabilizers, crosslinkers, or any combination thereof.

### Embodiment 155

The method of any one of embodiments 85-154, wherein the isocyanate comprises aliphatic isocyanate, aromatic isocyanate, or a combination thereof.

### Embodiment 156

The method of any one of embodiments 85-155, wherein the isocyanate comprises Hexamethylene diisocyanate (HDI), Isophorone diisocyanate (IPDI), Methylene bis(4-cy-clohexylisocyanate), Methylene diphenyl diisocyanates (MDI), Toluene diisocy-anates (TDI), Naphtalene diisocyanate (NDI), or any combination thereof.

### Embodiment 157

The method of any one of embodiments 85-156, wherein the lignin product is combined with one or more other polyols prior to being contacted with the isocyanate.

### Embodiment 158

The method of embodiment 157, wherein the lignin product is combined with the other polyols at a temperature that is about 20° C. to about 30° C., about 30° C. to about 40° C., about 40° C. to about 50° C., about 50° C., about 60° C., about 60° C., about 70° C., about 80° C., about 90° C., about 100° C., about 110° C., about 120° C., about 130° C., about 140° C., or about 150° C., 160° C., 170° C., or higher.

### Embodiment 159

The method of embodiment 157 or 158, wherein the lignin product is combined with the other polyols at about 140° C.

### Embodiment 160

The method of any one of embodiments 157-159, wherein the lignin product is combined with the other polyols for a period of time that is about 30 sec to about 1 min, about 1 min to about 5 min, about 5 min to about 1 hour, about 1 hour to about 24 hours, about 1 hour to about 18 hours, about 1 hour to about 12 hours, about 1 hour to about 6 hours, about 2 hours, about 3 hours, about 4 hours, about 6 hours, about 7 hours, about 8 hours, about 9 hours, about 10 hours, about 11 hours, about 13 hours, about 14 hours, about 15 hours, about 17 hours, about 19 hours, about 20 hours, about 21 hours, about 22 hours, about 23 hours, or about 24 hours.

### Embodiment 161

The method of any one of embodiments 157-160, wherein the lignin product is combined with the other polyols for a period of time that is about 15 min to 60 min.

### Embodiment 162

The method of any one of embodiments 157-161, wherein the contacting comprises: (1) combining the lignin product with the isocyanate to form a lignin-isocyanate mixture; and (2) adding one or more other polyols to the lignin-isocyanate mixture for the polymerization.

### Embodiment 163

The method of any one of embodiments 157-162, wherein the lignin product is liquefied before being combined with other polyols and/or the isocyanate.

### Embodiment 164

The method of embodiment 163, wherein the lignin product is liquefied by liquefaction reagents that comprise PEG-400 and glycerol.

### Embodiment 165

The method of embodiment 163 or 164, wherein the liquefaction of the lignin product is conducted at a temperature that is about 20° C. to about 30° C., about 30° C. to about 40° C., about 40° C. to about 50° C., about 50° C., about 60° C., about 60° C., about 70° C., about 80° C., about 90° C., about 100° C., about 110° C., about 120° C., about 130° C., about 140° C., about 150° C., about 160° C., about 170° C., or higher.

### Embodiment 166

The method of any one of embodiments 163-165, the liquefaction of the lignin product is conducted at a temperature about 140° C.

### Embodiment 167

The method of any one of embodiments 85-166, wherein the polymerization is carried out in the presence of additives that comprise viscosity reducers, surfactants, flame retardants, blowing agents, or any combination thereof.

### Embodiment 168

The method of embodiment 167, wherein the flame retardants comprise TCPP (Tri(beta-chloropropyl)phosphate).

### Embodiment 169

The method of embodiment 167 or 168, wherein the blowing agents comprise hydrocarbons, halogenated hydrocarbon, hydrofluorocarbon, hydrochlorofluorocarbon, hydrochlorocarbon, hydrofluorocarbon, pentafluoropropane, pentafluorobutane/heptafluoropropane, or any combination thereof.

### Embodiment 170

The method of any one of embodiments 85-169, wherein the polymerization is carried out in the presence of a catalyst.

### Embodiment 171

The method of embodiment 170, wherein the catalyst comprises a metal catalyst, amine catalyst, or a combination thereof.

### Embodiment 172

The method of embodiment 170 or 171, wherein the catalyst comprises mercury, lead, tin, bismuth, potassium and zinc, dibutyltin dilaurate, stannous octoate, potassium octoate, alkyl amines, ethanol amines, or any combination thereof.

### Embodiment 173

The method of any one of embodiments 85-172, wherein the polymerization is carried out at a temperature that is about 20° C. to about 30° C., about 30° C. to about 40° C., about 40° C. to about 50° C., about 50° C., about 60° C., about 60° C., about 70° C., about 80° C., about 90° C., about 100° C., about 110° C., about 120° C., about 130° C., about 140° C., or about 150° C., 160° C., 170° C., or higher.

### Embodiment 174

The method of any one of embodiments 85-173, wherein the polymerization is carried out for a time period of at most 24 hr, 12 hr, 8 hr, 6 hr, 4 hr, 2 hr, 1 hr, 45 min, 30 min, 20 min, 15 min, 10 min, 5 min, 1 min, or 30 sec.

### Embodiment 175

The method of any one of embodiments 85-174, wherein the polymerization is carried out for a time period of at most 60 min.

### Embodiment 176

The method of any one of embodiments 85-175, wherein the polymerization takes place faster than polymerization reaction under same conditions except without the lignin product.

### Embodiment 177

The method of any one of embodiments 85-176, wherein the polyurethane product is a polyurethane foam.

### Embodiment 178

The method of any one of embodiments 85-177, wherein the polyurethane product is a polyurethane plastic.

### Embodiment 179

The method of any one of embodiments 85-178, wherein the polyurethane product has a compressive strength higher than polyurethane product made under same conditions except without the lignin product.

### Embodiment 180

The method of any one of embodiments 85-179, wherein the biomass comprises algae, corn, grass, straw, wood, bark, sawdust, paper, poplars, willows, switchgrass, alfalfa, prairie bluestem, sugar palms, nypa palm, cassava, milo, sorghum, sweet potatoes, molasses, tubers, roots, stems, sago, cassaya, tapioca, rice peas, beans, potatoes, beets, fruits, pits, sorghum, sugar cane, rice, wheat, whole grains, rye, barley, bamboo, seeds, oats, or a combination thereof, or a derivative or byproduct thereof.

### Embodiment 181

The polyurethane product of any one of embodiments 85-180, wherein the biomass comprises a woody biomass.

### Embodiment 182

The polyurethane product of any one of embodiments 85-181, wherein the polyurethane product is a polyurethane foam.

### Embodiment 183

The polyurethane product of any one of embodiments 85-182, wherein the polyurethane product is a polyurethane plastic.

### Embodiment 184

A polyurethane product produced according to the method of any one of embodiments 85-183.

### Embodiment 185

A method of making a polyurethane foam, comprising:

(a) dissolving a powdered lignin directly in a solution comprising polyols other than lignin; and

(b) contacting the lignin-containing solution with an isocyanate and submitting the mixture for polymerization to produce the polyurethane foam.

### Embodiment 186

The method of embodiment 185, wherein the powdered lignin has a carbohydrate content of at most 20%, 15%, 12%, 10%, 8%, 6%, 5%, 4%, 3%, 2%, 1% by weight.

### Embodiment 187

The method of embodiment 185 or 186, wherein the powdered lignin has a carbohydrate content of at most 5% by weight.

### Embodiment 188

The method of any one of embodiments 185-187, wherein the powdered lignin has a sulfur content of at most 5%, 3%, 2%, 1.5%, 1%, 0.8%, 0.6%, 0.5%, 0.4%, 0.3%, 0.2%, 0.1%, 0.05%, 0.02%, or 0.01% by weight.

### Embodiment 189

The method of any one of embodiments 185-188, wherein the powdered lignin has a sulfur content of at most 0.2% by weight.

### Embodiment 190

The method of any one of embodiments 185-189, wherein the powdered lignin has an ash content of at most 5% by weight.

### Embodiment 191

The method of any one of embodiments 185-190, wherein the powdered lignin has a particle size that is in a range of about: 1-500 μm, 1-250 μm, 1-200 μm, or 1-150 μm.

### Embodiment 192

The method of any one of embodiments 185-191, wherein the powdered lignin has a particle size that is at most 50, 25, 15, or 10 μm on average.

### Embodiment 193

The method of any one of embodiments 185-192, wherein the powdered lignin has an ash content of at most 2% by weight.

### Embodiment 194

The method of any one of embodiments 185-193, wherein the dissolving is carried out with stirring the solution.

### Embodiment 195

The method of any one of embodiments 185-194, wherein the solution for the dissolution of the powdered lignin has a pH that is about: 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or 0.1, or in between any two of these values.

### Embodiment 196

The method of any one of embodiments 185-195, wherein the solution for the dissolution of the powdered lignin has a pH that is about: 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, or 13.9, or in between any two of these values.

### Embodiment 197

The method of any one of embodiments 185-196, wherein the dissolving is carried out at a temperature that is about 20° C. to about 30° C., about 30° C. to about 40° C., about 40° C. to about 50° C., about 50° C., about 60° C., about 60° C., about 70° C., about 80° C., about 90° C., about 100° C., about 110° C., about 120° C., about 130° C., about 140° C., or about 150° C., 160° C., 170° C., or higher.

### Embodiment 198

The method of any one of embodiments 185-197, wherein the dissolving is carried out at a temperature that is about 140° C.

### Embodiment 199

The method of any one of embodiments 185-198, wherein the polyurethane foam has a compressive strength higher than polyurethane foam made under same conditions except without the lignin product.

### EXAMPLES

The following examples serve to illustrate certain embodiments and aspects and are not to be construed as limiting the scope thereof.

### Example 1. Pretreatment of Biomass Using an Extruder

A twin screw extruder was used to perform four continuous runs of 224, 695, 1100, and 977 hours each on hardwood sawdust biomass feedstock. The extruder was run with indirect heating through the reactor walls until the end of the experiment. A flow rate of up to 300 lb/hr was reached through the extruder with direct steam injection to supply process heat. The materials of construction were acid resistant. The feed was metered through a weight belt feeder and fell into a crammer feeder supplying the barrel of the extruder. Two screws intermeshed and provided rapid heat and mass transfer when steam and sulfuric acid were injected through steam and acid ports connected to the cylindrical barrel of the extruder. The steam and acid supplying ports were sealed by reverse-flow sections in the screws. A hydraulically operated pressure control valve, seated in a ceramic seal, was used to control pressure in the reaction section of the extruder.

The solids were exposed to high temperature and pressure and low pH for a maximum of about 10 seconds in the reaction zone of the extruder before being exploded into the flash tank. Residence time in the reaction zone was controlled by the feed rate and rotational time of the screws. Hydroxymethyl furfural (HMF) and furfural, reversion inhibitors, were formed in small amounts during this pretreatment (e.g., a total of 0.3 to 0.5 wt. % of the dry pretreated product).

The pretreated material was cooled and pH adjusted prior to enzymatic hydrolysis where sugars were released. After about 48 to 56 hours of hydrolysis, the lignin rich solids were separated from the liquid sugar stream by filter press. The liquid sugar stream was further converted to a final product and the remaining lignin residues were water washed, dried, and mechanically ground and sifted through a 1 mm mesh.

### Example 2. Particle Size Following Pretreatment with a Twin Screw Extruder

This experiment was conducted to evaluate the particle size reduction that takes place during biomass pretreatment in a modified twin screw extruder. Cherry sawdust, with an average particle size of about 3 mm×3 mm×1 mm and an average moisture content of 31% was used as the raw biomass feedstock. The cherry biomass was fed into a ZSK-30 twin screw extruder, manufactured by Coperion, essentially as described in Example 1. The processing parameters used for the experiment are presented in Table 1.

TABLE 1
Particle Size Distribution Experimental Parameters

| | Mass Throughput | Pressure | Temp. | Acid Addition | Water Addition | Residence Time |
|---|---|---|---|---|---|---|
| Feedstock | Dry g/min | psig | ° C. | g/min | g/min | seconds |
| Cherry | 398.4 | 400 | 231 | 7.6 | 1134 | 10 |
| Sawdust | | | | | | |

The cherry sawdust was processed on a continuous basis. The final moisture content of the processed cherry sawdust was about 76.8%. Once steady state was achieved a sample of the pretreated material was collected for particle size analysis. The sample was analyzed through a Mie Scattering theory using a Horiba LA-920, capable of measuring particle diameters from 0.02 μm to 2000 μm. The results indicated a significant particle size reduction occurring throughout the pretreatment process. The average particle size was reduced from 3 mm in the raw material to 20.75 μm in the pretreated effluent. A summary of the particle size distribution is presented in FIG. 2.

### Example 3. Bulk Density of Hydrolysate-Derived Lignin

Two 250-mL samples of lignin, which were derived from barkless mixed hardwood, were tested to determine bulk density as well as other powder flow characteristics. The first sample had a mean particle size of 10 μm. The second sample was placed through a 1-mm sieve where all particles 1-mm and smaller were allowed to pass through. The 1-mm sieve was selected based on the maximum particle size allowable for the powder flow measurement technology.

The hardwood was pretreated using the above-described pretreatment technology for conversion of available C5 sugars. The material was subsequently subjected to enzymatic hydrolysis and separation for the removal of available C6 sugars. The remaining lignin in suspension was then processed for solids removal. The material was initially separated to 50% total solids removing the majority of the dissolved solids in solution. Remaining sugars were measured to be 0.04, 0.06, and 0.07−g_{sugar}/g_{cake} at sample points.

The lignin was granulated and allowed to dry further to 10% moisture prior to preparation of the samples. After drying the material was sent directly through a 1-mm sieve to recover a 250-mL sample of sizes 1-mm or less. A separate 250-mL sample was produced by pulverizing the agglomerated particles into their fundamental sizes which average 10 μm.

The dry lignin powder had a bulk density of 461-750 kg/m³.

### Example 4. Content of Hydrolysate-Derived Lignin

Analysis of hydrolysate-derived lignin is shown in Table 2.

TABLE 2
Analysis of lignin

| | | | Moisture | |
|---|---|---|---|---|
| Test | Method | Units | Free | As Received |
| Moisture Total | ASTM E871 | wt. % | | 22.74 |
| Ash | ASTMD1102 | wt. % | 1.68 | 1.30 |
| Volatile Matter | ASTM D3175 | wt. % | 62.50 | 48.29 |
| Fixed Carbon by | ASTM D3172 | wt. % | 35.82 | 27.68 |
| Difference | | | | |
| Sulfur | ASTM D4239 | wt. % | 0.174 | 0.134 |
| SO₂ | Calculated | Lb/mmbtu | | 0.317 |
| Net Cal. Value at | ISO 1928 | GJ/tonne | 23.01 | 13.18 |
| Const. Pressure | | | | |
| Net Cal. Value at | ISO 1928 | J/g | 23012 | 13182 |
| Const. Pressure | | | | |
| Gross Cal. Value | ASTM E711 | J/g | 24231 | 18721 |
| at Const. Vol. | | | | |
| Gross Cal. Value | ASTM E711 | Btu/lb | 10418 | 8049 |
| at Const. Vol. | | | | |
| Carbon | ASTM D5373 | wt. % | 59.43 | 45.92 |
| Hydrogen* | ASTM D5373 | wt. % | 5.63 | 4.35 |
| Nitrogen | ASTM D5373 | wt. % | 0.53 | 0.41 |
| Oxygen* | ASTM D3176 | wt. % | 32.56 | 25.16 |
| Chlorine | ASTM D6721 | mg/kg | 36 | 28 |
| Fluorine | ASTM D3761 | mg/kg | 9 | 7 |
| Mercury | ASTM D6722 | mg/kg | 0.001 | 0.001 |

As received values do not include hydrogen and oxygen in the total moisture.

### Example 5. Liquefaction of Hydrolysate-Derived Lignin

SWE enzymatic hydrolysis derived lignin was prepared as in Example 1 and liquefied. In brief, liquefaction reagents PEG-400 and glycerol were mixed in an 80:20 (w/w) ratio, and the ratio of reagents to dry lignin was 5:1 (w/w). Based on the weight of reagents added, 1.5% sulfuric acid solution, ACS reagent, 95.0-98.0%, was dosed. The solution was prepared in a 250 mL Erlenmeyer flask on a hot plate with a magnetic stirrer and heated to 140° C. in ˜15 minutes, at which point it was held for 0 to 60 minutes. At the completion of the reaction time, the flask was submerged in an ice bath until the solution was cooled to room temperature, ˜5 minutes. The solution was then neutralized with 50% NaOH solution to bring the pH between 6 and 8. Using the same procedure for each, heating times of 0, 15, 30, 45 and 60 minutes were tested and the results are in Table 3.

TABLE 3
Experimental set-up for liquefaction process

| | | | | 1.5% of | |
|---|---|---|---|---|---|
| | | | | PEG/ | |
| | 5:1 | 80% | 20% | Glycerol | |
| | 90% dry | PEG-400 | Glycerol | 95% Sulfuric | @140° C. |
| Formula | Lignin (g) | (g) | (g) | Acid (uL) | Time (min) |
| 1 | 22.2 | 80 | 20 | 858 | 0 |
| 2 | 22.2 | 80 | 20 | 858 | 15 |
| 3 | 22.2 | 80 | 20 | 858 | 30 |
| 4 | 22.2 | 80 | 20 | 858 | 45 |
| 5 | 22.2 | 80 | 20 | 858 | 60 |

### Example 6. Polyurethane Foam

To create a polyurethane foam with a liquefied lignin polyol replacement, a foam kit was utilized (Innovating Science® by Aldon Corporation—Polyurethane Foam IS7018). The kit is comprised as follows: Solution A (mixed polyfunctional isocyanates); 50% Methylene bis phenylisocyanate CAS#: 101-68-8, 50% Polymeric diphenylmethane diisocyante CAS#: 9016-87-9, and Solution B (Polyurethane resin); <10% 1,1,1,3,3-Pentafluroropropane CAS#: 460-73-1; <1% Tertiary amine catalysts.

All foam formulas were made up to a total weight of 20 g, using varying amounts of Solution A Solution B, and the liquefied lignin polyol stream (See Table 4). Solutions were weighed out, mixed vigorously for about 15 seconds or until visibly homogenous based on color, and then set on a table undisturbed. Time to fully expand was measured from the moment the product was mixed until it was visibly unchanged in height. Time to fully harden was determined based on when the top of the foam could be touched without an imprint or disruption in the surface of the foam. Height was measured as the average center height of the foam after the container was removed (See Table 4).

TABLE 4
Experimental set-up for mixing polyurethane foam ingredients

| | | | SWE | 80:20 PEG- |
|---|---|---|---|---|
| | | | Liquefied | 400:Glycerol |
| | Solution A (g) | Solution B (g) | Lignin (g) | (g) |
| (+) Control | 10 | 10 | 0 | 0 |
| (commercial) | | | | |
| (−) Control | 10 | 5 | 0 | 5 |
| Experimental | 10 | 5 | 5 | 0 |

Results

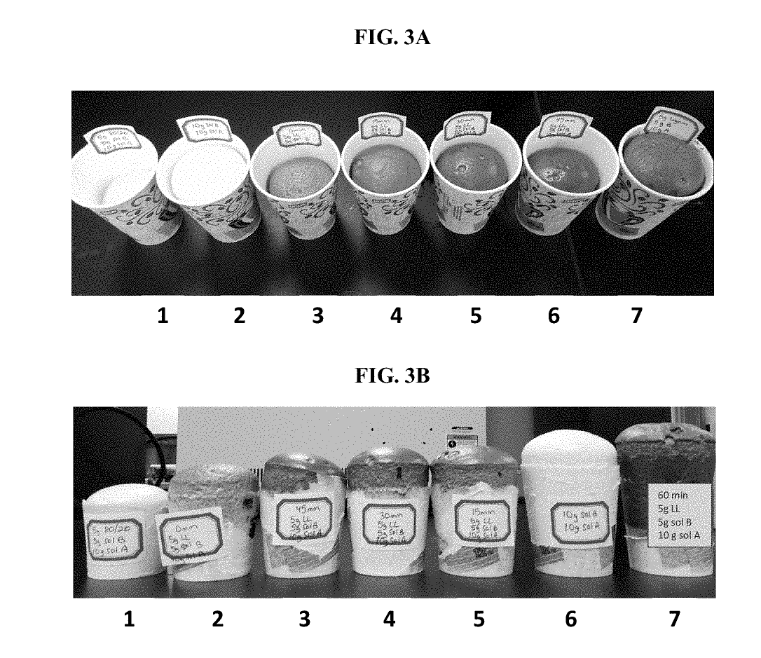

The results of the foam product trials using liquefied lignin are shown below in Table 5 and FIGS. 3A and 3B. FIG. 3A shows foam products, in the same order as in Table 5. In the figure, from left to right, “1” shows the foam product from a 50% solution A+25% solution B+25% 80:20 PEG-400:glycerol mixture (without lignin), “2” shows the foam product from 50% solution A+50% solution B, “3” shows the foam product from 50% solution A+25% solution B+25% liquefied lignin with 0 minutes of heating, “4” shows the foam product from 50% solution A+25% solution B+25% liquefied lignin with 15 minutes of heating, “5” shows the foam product from 50% solution A+25% solution B+25% liquefied lignin with 30 minutes of heating, “6” shows the foam product from 50% solution A+25% solution B+25% liquefied lignin with 45 minutes of heating, “7” shows the foam product from 50% solution A+25% solution B+25% liquefied lignin with 60 minutes of heating. Heating was at 140° C.

TABLE 5
Polyurethane foam mixture formula and results of foam formation

| | | | | Time | Time | |
|---|---|---|---|---|---|---|
| | | | | to | to | Height |
| Liquefied | Solution | Solution | Liquefied | Fully | Fully | without |
| Lignin | A | B | Lignin | Expand | Harden | cup |
| Parameter | (g) | (g) | (g) | (sec) | (sec) | (cm) |
| PEG/ | 10 | 5 | 5 | 365 | 850 | 6.5 |
| Glycerol | | | | | | |
| Only | | | | | | |
| — | 10 | 10 | 0 | 395 | 930 | 10.5 |
| 0 min | 10 | 5 | 5 | 260 | 600 | 7.5 |
| 15 min | 10 | 5 | 5 | 174 | 300 | 9.5 |
| 30 min | 10 | 5 | 5 | 172 | 300 | 9.0 |
| 45 min | 10 | 5 | 5 | 188 | 210 | 8.5 |
| 60 min | 10 | 5 | 5 | — | — | 11.0 |

FIG. 3B displays the final foam products in height order to show total growth of each product. From left to right; “1” shows the foam product from a 50% solution A+25% solution B+25% 80:20 PEG-400:glycerol mixture (without lignin), “2” shows the foam product from a 50% solution A+25% solution B+25% liquefied lignin with 0 minutes of heating, “3” shows the foam product from a 50% solution A+25% solution B+25% liquefied lignin with 45 minutes of heating, “4” shows the foam product from a 50% solution A+25% solution B+25% liquefied lignin with 30 minutes of heating, “5” shows the foam product from a 50% solution A+25% solution B+25% liquefied lignin with 15 minutes of heating, “6” shows the foam product from a 50% solution A+50% solution B, “7” shows the foam product from a 50% solution A+25% solution B+25% liquefied lignin with 60 minutes of heating.

The liquefied lignin polyol product promoted foam expansion when heated for at least 15 minutes, compared to the control without lignin added to the PEG-400/glycerol. On average, foams containing liquefied lignin expanded to their final size 56% faster than the commercial control and 51% faster than the control without lignin added to the PEG-400/glycerol. On average, the liquefied lignin containing foams hardened 71% faster than the standard commercial foam product. Even with no heating the foam product with lignin still formed a foam although this foam was more heterogeneous in particle distribution.

### Example 7. Polyurethane Foam with Enhanced Mechanical Strength

In another experiment to create polyurethane foam, Polyol formulation Urepac ES 2772-0517 was used to dissolve powdered lignin produced as described above in Example 1.

The base Polyether polyol mixture used in this formulation was prepared separately and a mild acid used to aid the solution of the powdered lignin. This mixture was heated to 140° C. and the powdered lignin was added slowly with stirring as follows:

| | |
|---|---|
| Acidic Base Polyol mixture: | 100 parts by weight |
| Powdered Lignin: | 20 parts by weight |

The powdered lignin was dissolved in the polyol mixture and was left to cool overnight before polymerization. This polyol/lignin solution was then made up the complete Urepac ES 2772-0517 formulation with the addition of the remaining ingredients as follows:

| | |
|---|---|
| Acidic Polyol/Lignin mix: | 111.0 parts by weight |
| Fire retardant: | 3.9 parts by weight |
| Amine catalyst: | 0.6 parts by weight |
| Foam stabiliser: | 1.2 parts by weight |
| Blowing agent combination: | 2.8 parts by weight |

This mixture was then compared to a control batch of ES 2772-0517 without the powdered lignin (“under the same conditions”), by making ‘free rise’ foam samples in a 300 mm*300 mm*300 mm cardboard box and testing the resultant foam by measuring Reaction Profile, Free Rise Density, and Compressive Strength. The testing results are shown in Table 6.

TABLE 6
Performance of powdered lignin-PU foam

| | | Powdered |
|---|---|---|
| Parameters | Control PU | lignin-PU |
| Cream Time (sec) | 55 | 55 |
| End of Rise Time (sec) | 245 | 255 |
| Tack-free Time (sec) | 280 | 300 |
| Compressive Strength | 130.0 | 155.0 |
| (kPa) | | |
| Free Rise Density (g/l) | 35.0 | 35.5 |

From the measurement, the addition of the powdered lignin at the designated level does not adversely affect the processability of the Rigid Polyurethane Foam system Urepac ES 2772-0517. And, the addition of the powdered lignin improves the Compressive Strength of the rigid foam (makes it harder) by approximately 20%.

### Example 8. Biodegradable Films

The phenolic hydroxyl group in the C-lignin is replaced with Microcrystalline cellulose is used to prepare microcrystalline cellulose bearing surface azide (MCC-Az) according to Sadeghifar H, et al. J Mater. Sci. (2011) 46:7344. Doi:10.1007/s10853-011-5696-0. The MCC-Az is dissolved in a mixture of DMAc and LiCl to form a solution of dissolved cellulose (Chao Zhang, et al. 2014 J. Phys. Chem. B. 118:9507) prior to mixing with the lignin.

The phenolic hydroxyl group in the C-lignin is replaced with a propargyl group using propargyl bromide in accordance with Sanghamitra S. 2013 Biomacromolecules 14:3399-408, to make propargylated C-Lignin. Then, 0.2-5.0% of proparylated C-Lignin is combined with the cellulose solution in a click reaction in accordance with Sadeghifar, op cit., to produce a C-Lignin/cellulose solution. This final solution of cellulose and C-lignin is cast onto a smooth non-reactive surface and immersed in an acetone bath for 1-2 hr. The cast films are washed in cold water for several hours to remove salts and then allowed to dry at room temperature before being peeled off the non-reactive surface.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A polyurethane product comprising a polymerization product of an isocyanate and polyols that comprise a lignin product; wherein the polyurethane product has a higher compressive strength than polyurethane made under same conditions except without the lignin product; and wherein the lignin product is a solid residue from a pretreatment and hydrolysis of a biomass, whereby at least 80% of carbohydrates in the biomass are extracted and separated from the solid residue.

2. A polyurethane product comprising a polymerization product of an isocyanate and polyols that comprise a lignin product, the lignin product being made by:
(a) pretreating a biomass within a pretreatment unit at an elevated temperature and pressure to produce a pretreated biomass;
(b) hydrolyzing the pretreated biomass to produce soluble carbohydrates and lignin residue; and
(c) water washing and drying the lignin residue to produce the lignin product.

3. The polyurethane product of claim 1 or 2, wherein the lignin product has a carbohydrate content of at most 5% by weight.

4. The polyurethane product of any one of claims 1-3, wherein the lignin product has a sulfur content of at most 0.2% by weight.

5. The polyurethane product of any one of claims 1-4, wherein the lignin product has an ash content of at most 2% by weight.

6. The polyurethane product of any one of claims 1-5, wherein about 1% to about 30% of the polyurethane product by weight is the lignin product.

7. The polyurethane product of any one of claims 1-6, wherein the lignin product is at least 15% of the polyols by weight.

8. The polyurethane product of any one of claim 1 or 3-7, wherein the pretreatment comprises:
(i) pretreating the biomass within a pretreatment unit at an elevated temperature and pressure to produce a pretreated biomass;
(ii) hydrolyzing the pretreated biomass to produce soluble carbohydrates and lignin residue; and
(iii) water washing and drying the lignin residue to produce the lignin product.

9. The polyurethane product of any one of claims 2-8, wherein the pretreating comprises mechanical processing of the biomass for particle size reduction.

10. The polyurethane product of claim 9, wherein the reduced particle size is about 15-25 μm on average.

11. The polyurethane product of any one of claims 2-10, wherein the pretreating comprises providing a non-pH neutral medium to the biomass in the pretreatment unit, the non-pH neutral medium comprising sulfuric acid.

12. The polyurethane product of claim 11, wherein the sulfuric acid has a concentration of 5% or less by biomass weight.

13. The polyurethane product of any one of claims 2-12, wherein the pretreating comprises steam explosion.

14. The polyurethane product of any one of claims 2-13, wherein the pretreatment unit comprises:
a. a barrel defining an inner chamber and comprising an inlet port near of first end of the barrel and an end flange plate at a second end of the barrel;
b. one or more rotatable screws configured to move the biomass through the inner chamber of the barrel and containing one or more sections configured to form one or more plugs from the biomass to separate the inner chamber of the barrel into two or more zones, including a feeder zone and a reaction zone; and
c. a pressure actuated discharge valve connected to the end flange plate and configured to open and close in response to pressure within the barrel, thereby allowing for continuous production of a pretreated biomass composition comprising a liquid fraction comprising monosaccharides and solid particles comprising cellulose.

15. The polyurethane product of any one of claims 1-14, wherein the lignin product has a particle size that is about 15-25 μm on average.

16. The polyurethane product of any one of claims 1-15, wherein the biomass comprises algae, corn, grass, straw, wood, bark, sawdust, paper, poplars, willows, switchgrass, alfalfa, prairie bluestem, sugar palms, nypa palm, cassava, milo, sorghum, sweet potatoes, molasses, tubers, roots, stems, sago, cassaya, tapioca, rice peas, beans, potatoes, beets, fruits, pits, sorghum, sugar cane, rice, wheat, whole grains, rye, barley, bamboo, seeds, oats, or a combination thereof, or a derivative or byproduct thereof.

17. The polyurethane product of any one of claims 1-16, wherein the biomass comprises a woody biomass.

18. The polyurethane product of any one of claims 1-17, wherein the polyurethane product is a polyurethane foam.

19. The polyurethane product of any one of claims 1-18, wherein the polyurethane product is a polyurethane plastic.

20. A polyurethane foam comprising a polymerization product of an isocyanate and a lignin-containing solution, the lignin-containing solution formed by dissolving a powdered lignin directly in a solution comprising polyols other than lignin.

21. The polyurethane foam of claim 20, wherein the powdered lignin has a carbohydrate content of at most 5% by weight.

22. The polyurethane foam of any one of claims 20-21, wherein the powdered lignin has a sulfur content of at most 0.2% by weight.

23. The polyurethane foam of any one of claims 20-22, wherein the powdered lignin has an ash content of at most 2% by weight.

24. The polyurethane foam of any one of claims 20-23, wherein the powdered lignin has a particle size that is in a range of 15-25 nm on average.

25. The polyurethane foam of any one of claims 20-24, wherein the solution for the dissolution of the powdered lignin has a pH that is about: 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or 0.1, or in between any two of these values.

26. The polyurethane foam of any one of claims 20-25, wherein the polyurethane foam has a compressive strength higher than polyurethane foam made under same conditions except without the lignin product.

27. A method of preparing a polyurethane product comprising: contacting an isocyanate with polyols that comprise a lignin product under conditions sufficient for a polymerization reaction to produce the polyurethane product; wherein the polyurethane product has a higher compressive strength than polyurethane made under same conditions except without the lignin product; and wherein the lignin product is a solid residue from a pretreatment and hydrolysis of a biomass, whereby at least 80% of carbohydrates in the biomass are extracted and separated from the solid residue.

28. A method of preparing a polyurethane product comprising:
(a) pretreating a biomass within a pretreatment unit at an elevated temperature and pressure to produce a pretreated biomass;
(b) hydrolyzing the pretreated biomass to produce soluble carbohydrates and lignin residue;
(c) water washing and drying the lignin residue to produce a lignin product; and
(d) contacting an isocyanate with polyols that comprise the lignin product under conditions sufficient for a polymerization reaction to produce the polyurethane product.

29. The method of claim 27 or 28, wherein about 1% to about 30% of the polyurethane product by weight is the lignin product.

30. The method of any one of claims 27-29, wherein the lignin product is at least 15% of the polyols by weight.

31. The method of any one of claim 27 or 29-30, wherein the pretreatment comprises:
(i) pretreating the biomass within a pretreatment unit at an elevated temperature and pressure to produce a pretreated biomass;
(ii) hydrolyzing the pretreated biomass to produce soluble carbohydrates and lignin residue; and
(iii) water washing and drying the lignin residue to produce the lignin product.

32. The method of any one of claims 27-31, wherein the pretreating comprises mechanical processing of the biomass for particle size reduction.

33. The method of claim 32, wherein the reduced particle size is about 15-25 μm on average.

34. The method of any one of claims 28-33, wherein the pretreating comprises providing a non-pH neutral medium to the biomass in the pretreatment unit, the non-pH neutral medium comprising sulfuric acid.

35. The method of claim 34, wherein the sulfuric acid has a concentration of 5% or less by biomass weight.

36. The method of any one of claims 28-35, wherein the pretreating comprises steam explosion.

37. The method of any one of claims 27-36, wherein the pretreatment unit comprises:
a. a barrel defining an inner chamber and comprising an inlet port near of first end of the barrel and an end flange plate at a second end of the barrel;
b. one or more rotatable screws configured to move the biomass through the inner chamber of the barrel and containing one or more sections configured to form one or more plugs from the biomass to separate the inner chamber of the barrel into two or more zones, including a feeder zone and a reaction zone; and
c. a pressure actuated discharge valve connected to the end flange plate and configured to open and close in response to pressure within the barrel, thereby allowing for continuous production of a pretreated biomass composition comprising a liquid fraction comprising monosaccharides and solid particles comprising cellulose.

38. The method of any one of claims 27-37, wherein the lignin residue has a particle size that is about 15-25 μm on average.

39. The method of any one of claims 27-38, wherein the lignin product has a carbohydrate content of at most 5% by weight.

40. The method of any one of claims 27-39, wherein the lignin product has a sulfur content of at most 0.2% by weight.

41. The method of any one of claims 27-40, wherein the lignin product has an ash content of at most 2% by weight.

42. The method of any one of claims 27-41, the polyols further comprises polyether polyol, polyester polyol, or a combination thereof.

43. The method of any one of claims 27-42, wherein the isocyanate comprises aliphatic isocyanate, aromatic isocyanate, or a combination thereof.

44. The method of any one of claims 27-43, wherein the lignin product is combined with one or more other polyols prior to being contacted with the isocyanate.

45. The method of any one of claims 27-44, wherein the lignin product is liquefied before being contacted with the isocyanate.

46. The method of any one of claims 27-45, wherein the polyurethane product is a polyurethane foam.

47. The method of any one of claims 27-46, wherein the polyurethane product is a polyurethane plastic.

48. The method of any one of claims 27-47, wherein the polyurethane product has a compressive strength higher than polyurethane product made under same conditions except without the lignin product.

49. The method of any one of claims 27-48, wherein the biomass comprises algae, corn, grass, straw, wood, bark, sawdust, paper, poplars, willows, switchgrass, alfalfa, prairie bluestem, sugar palms, nypa palm, cassava, milo, sorghum, sweet potatoes, molasses, tubers, roots, stems, sago, cassaya, tapioca, rice peas, beans, potatoes, beets, fruits, pits, sorghum, sugar cane, rice, wheat, whole grains, rye, barley, bamboo, seeds, oats, or a combination thereof, or a derivative or byproduct thereof.

50. The polyurethane product of any one of claims 27-49, wherein the biomass comprises a woody biomass.

51. The polyurethane product of any one of claims 27-50, wherein the polyurethane product is a polyurethane foam.

52. The polyurethane product of any one of claims 27-51, wherein the polyurethane product is a polyurethane plastic.

53. A polyurethane product produced according to the method of any one of claims 27-52.

54. A method of making a polyurethane foam, comprising:
(a) dissolving a powdered lignin directly in a solution comprising polyols other than lignin; and
(b) contacting the lignin-containing solution with an isocyanate and submitting the mixture for polymerization to produce the polyurethane foam.

55. The method of claim 54, wherein the powdered lignin has a carbohydrate content of at most 5% by weight.

56. The method of claim 54 or 55, wherein the powdered lignin has a sulfur content of at most 0.2% by weight.

57. The method of any one of claims 54-56, wherein the powdered lignin has an ash content of at most 2% by weight.

58. The method of any one of claims 54-57, wherein the powdered lignin has a particle size that is about 15-25 μm on average.

59. The method of any one of claims 54-58, wherein the solution for the dissolution of the powdered lignin has a pH that is about: 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or 0.1, or in between any two of these values.

60. The method of any one of claims 54-59, wherein the polyurethane foam has a compressive strength higher than polyurethane foam made under same conditions except without the lignin product.
